(19) United States
(12) Patent Application Publication
(10) Pub. No.: US 2009/0178212 A1
(43) Pub. Date: Jul. 16, 2009

(54) Fabric color restoration composition, article, and method

(76) Inventors: Errol Hoffman Wahl, Cincinnati, OH (US); Michele Ann Watkins, New Richmond, OH (US); Jodi Lee Brown, Cincinnati, OH (US); Gayle Marie Frankenbach, Cincinnati, OH (US); Brent Michael Heist, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/008,504

(22) Filed: Jan. 11, 2008

(51) Int. Cl. D06P 5/02; C08G 77/06

(52) U.S. Cl. 8/441; 528/12

(57) ABSTRACT

The present invention relates to a stable, preferably well dispersed, more preferably translucent, and even more preferably clear, aqueous fabric color-restoring composition, fabric color-restoring methods, and articles of manufacture that use such fabric color-restoring composition. The fabric color-restoring composition comprises an effective amount of a silicone polymer fabric color-restoring agent, typically the minimum levels of fabric color-storing agent included in the composition are at least about 1.75%, preferably at least about 2.0%, more preferably at least about 2.5%, even more preferably at least about 3.0% and typically maximum levels of fabric color-restoring agent are less than about 10.0%, preferably less than about 7.0%, particularly in the range of about 3.0% to about 6.0%; and optionally, but preferably, an effective amount to increase the coefficient of static friction, of a static friction-increasing agent.

### TECHNICAL FIELD

The present invention relates to fabric care compositions and methods for treating fabrics in order to improve various properties of fabrics, in particular, restoration of color appearance in faded fabrics.

### BACKGROUND OF THE INVENTION

Age and laundering of fabrics, especially clothing, results in fading and dulling of non-white colors that eventually results in clothing obsolescence and expensive replacement. As a result, there has been a long-felt need to find a product that is simple and easy to use for at least partially restoring faded, non-white color in fabrics, particularly in articles of clothing.

Various compositions are disclosed in patents and applications of this assignee, as well as other applicants, as wrinkle control compositions. The commercial wrinkle control compositions commercialized by this assignee, however, do not include sufficient silicone polymer to produce visible color restoration of colored, faded fabrics. Prior art wrinkle control compositions are exemplified in U.S. Pat. No. 5,532,023, issued Jul. 2, 1996 to Vogel et al., disclosing aqueous wrinkle control compositions containing non-volatile silicone and film forming polymers. Preferred silicones include reactive silicones and amino-functional silicones, known as “amodimethicones”. The commercial composition containing such silicones contains about 1.5% silicone polymer and is applied to fabric from a spray dispenser. It has also been found that in using spray treatments, an appreciable amount of the aqueous composition misses the fabric, and instead falls on flooring surfaces, such as rugs, carpets, concrete floors, tiled floors, linoleum floors, and bathtub floors, which can leave a silicone layer that is accumulated on and/or cured on and/or bonded to the flooring surfaces. Such silicones that are accumulated on such surfaces, and especially those that are bonded to such surfaces, are difficult to remove. Flooring surfaces thus can become slippery and can present a safety hazard to the household members.

U.S. Pat. No. 5,573,695, issued Nov. 12, 1996 to E. F. Targosz discloses an aqueous wrinkle removal composition containing a vegetable oil-based cationic quaternary ammonium surfactant, and an anionic fluorosurfactant. Similarly, U.S. Pat. No. 4,661,268, issued Apr. 28, 1987 to Jacobson et al. discloses a wrinkle removal spray comprising an aqueous alcoholic composition containing a dialkyl quaternary ammonium salt and a silicone surfactant and/or a fluoro surfactant. U.S. Pat. No. 5,100,566, issued Mar. 31, 1992 to Agbomeirele et al., discloses a method of reducing wrinkles in fabric by spraying the fabric with an aqueous alcoholic solution of an anionic siliconate alkali metal salt. U.S. Pat. No. 4,806,254, issued Feb. 21, 1989 to J. A. Church discloses fabric wrinkle removal aqueous alcoholic solution containing glycerin and a nonionic surfactant.

### SUMMARY OF THE INVENTION

The compositions and methods described herein restore faded, non-white color in fabrics, including clothing, dry cleanables, linens, bed clothes, upholstery, and draperies, and have supplemental benefits such as wrinkle reduction, freshness, and improved softness. Other surfaces can be treated including, but not limited to, automobile interiors, shoes, and furniture. The compositions and methods described herein can be used on damp or dry clothing to restore faded color and give clothes a ready to wear or use look. The compositions and methods described herein also essentially eliminate or reduce the need for touch up ironing usually associated with closet, drawer, and suitcase storage of garments. Fabric color restoration in the context of this invention means restoration of color appearance, unless the composition optionally contains a dye or colorant to “re-color” faded colored fabrics.

In a preferred aspect, an additional benefit of the compositions and methods of the present invention are improved garment drape, body and crispness.

When ironing is desired however, the compositions described herein can also act as an excellent ironing aid. The compositions make the task of ironing easier and faster by creating less iron drag. When used as an ironing aid, the compositions help produce a crisp, smooth appearance, while partially restoring faded color.

Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The present invention relates to a stable, preferably well dispersed, more preferably translucent, and even more preferably clear, aqueous fabric color-restoring compositions, fabric color-restoring methods, and articles of manufacture that use such fabric color-restoring compositions. The fabric color-restoring compositions include:
A. an effective amount of a silicone polymer fabric color-restoring agent, typically the minimum levels of fabric color-restoring agent included in the composition are at least about 1.75%, preferably at least about 2.0%, more preferably at least about 2.5%, even more preferably at least about 3.0% and typically maximum levels of fabric color-restoring agent are less than about 10.0%, preferably less than about 7.0%, particularly in the range.of about 3.0% to about 6.0%;
B. optionally, an effective amount to soften fibers and/or soften any shape retention polymer, when present, of hydrophilic plasticizer wrinkle control agent;
C. optionally, but preferably, to reduce surface tension, and/or to improve performance, active spreading, and formulatability, an effective amount of surfactant;
D. optionally, but preferably, an effective amount to increase the coefficient of static friction, of a static friction-increasing agent;
E. optionally, but preferably, an effective amount to provide olfactory effects of perfume;
F. optionally, an effective amount, to kill, or reduce the growth of microbes, of antimicrobial active;
G. optionally, an effective amount to provide improved antimicrobial action for, e.g., the antimicrobial active, aminocarboxylate chelator;
H. optionally, an effective amount of solubilized, water-soluble, antimicrobial preservative, especially when said antimicrobial active is not sufficient to act as a preservative; and
I. aqueous carrier, said composition preferably being essentially free of any material that would soil or stain fabric under usage conditions.

The present invention also relates to concentrated compositions, which are diluted to form compositions with the usage concentrations, as given hereinabove, for use under “usage conditions”. For concentrated compositions typically the silicone polymer fabric color-restoring agent is at least about 10%, alternatively at least about 20%, and alternatively at least about 30%.

In a preferred embodiment, the color-restoring compositions described herein are incorporated into a spray dispenser to create an article of manufacture that can facilitate treatment of fabrics and/or surfaces with said compositions containing the color-restoring agent and other optional ingredients at a level that is effective, yet is not readily discernible when dried on fabrics, with the exception of color fade restoration. The spray dispenser comprises manually activated and non-manual powered (operated) spray means and a container containing the color-restoration composition. In one embodiment of the color restoration compositions described herein, a static friction increasing component, such as cyclodextrin or a polyacrylate, is included in an increased amount sufficient to reduce or eliminate this potential safety hazard.

In a preferred embodiment, the present invention also comprises the use of small particle diameter droplets of the compositions herein to treat fabrics, to provide superior performance, e.g., the method of applying the compositions to fabric, etc. as very small particles (droplets) preferably having weight average diameter particle sizes (diameters) of from about 5 μm to about 250 μm, more preferably from about 10 μm to about 120 μm, and even more preferably from about 20 μm to about 100 μm.

In one embodiment, the composition is delivered from the container at a spray rate of about 0.1 grams per second to about 2 grams per second. In one embodiment, the composition is sprayed to deliver about 2 grams of the composition per square foot and requires a drying time for a fabric of about 5 minutes to about 15 minutes.

### DETAILED DESCRIPTION OF THE INVENTION

### Color-Restoring Agents

As discussed before, the present invention relates to methods and compositions for fabric color restoration that utilize, at least in an effective amount to restore faded, non-white color. Typically, minimum levels of silicone polymer color restoration agent included in the composition are at least about 1.75%, preferably at least about 2.0%, more preferably at least about 2.5% even more preferably at least about 3.0% by weight, based on the total weight of the composition. Typically maximum levels of silicone polymer color restoration agent included in the composition are less than about 10%, preferably less than about 7.0%, based on the total weight of the composition. Preferably, the agent is present in the composition in an amount of about 3.0% to about 6.0%. Concentrated compositions can be much higher in the level of silicone polymer fabric color-restoring agent, up to about 30% or more.

Specifically, the preferred fabric color restoration silicone polymers are the silicone polyethers (also known as dimethicone copolyols); volatile silicones, such as dimethylsiloxane silicone; and curable silicones such as aminosilicones, phenylsilicones and hydroxylsilicones. The word “silicone” or “silicone polymer” as used herein preferably refers to soluble or dispersible neat silicone fluids, self emulsifying, or emulsified silicones, including those that are commercially available as single components or as mixture, e.g., compositions formulated by the supplier to achieve solubilization and/or emulsification of the silicone, unless otherwise described. Preferably, the silicones comprise at least some hydrophobic moieties; are neither irritating, toxic, nor otherwise harmful when applied to fabric (for example, not cause staining or when they come in contact with human skin; and are chemically stable under normal use and storage conditions.

When the compositions described herein are to be dispensed from a spray dispenser in a consumer household setting, the non-curable silicones such as silicone polyethers and polydimethylsilicones are preferred. Curable and/or reactive silicones such as amino-functional silicones and silicones with reactive groups such as Si—OH, Si—H, silanes, and the like, are particularly useful when used in conjunction with an increased level of static friction-increasing agent in accordance with one embodiment of the color restoring compositions described herein, such as a cyclodextrin, because the portion of the composition that is sprayed but misses the garment, and falls instead on flooring surfaces, such as a rug, carpet, concrete floor, tiled floor, linoleum floor, bathtub floor, otherwise can leave a silicone layer that is cured and/or bonded to the flooring surfaces. Such silicones that are bonded to surfaces and do not contain increased levels, e.g., at least about 0.9% of a static friction increasing agent, can cause flooring surfaces to become slippery, and can present a safety hazard to household members. Some aminofunctional silicones also cause fabric yellowing. Thus, the silicones that cause fabric discoloration, as opposed to fabric color restoration, are not preferred.

A highly preferred, but non-limiting class of silicones useful as the color restoration agent of the compositions described herein is the class of silicone polyethers alternately know as dimethicone copolyols and polyalkylene oxide polysiloxanes. Typically the polyalkylene oxide polysiloxanes have a dimethyl polysiloxane hydrophobic moiety and one or more hydrophilic polyalkylene chains. The hydrophilic polyalkylene chains can be incorporated as side chains (pendant moieties) or as block copolymer moieties with the polysiloxane hydrophobic moiety. Silicone polyethers are described by the following general formulas:

R¹—CH₃)₂SiO—[(CH₃)₂SiO]ₐ—[(CH₃)(R₁)SiO]_{b—Si(CH}₃)₂—R¹

wherein a+b are from about 1 to about 50, preferably from about 1 to about 30, more preferably from about 1 to about 25, and each R¹ is the same or different and is selected from the group consisting of methyl and a poly-(ethyleneoxide/propyleneoxide) copolymer group having the general formula:

—(CH₂)ₙO(C₂H₄O)_{c}(C₃H₆O)_{d}R²

with at least one R¹ being a poly(ethyleneoxy/propyleneoxy) copolymer group, and wherein n is 3 or 4, preferably 3; total c (for all polyalkyleneoxy side groups) has a value of from 1 to about 100, preferably from about 6 to about 100; total c+d has a value of from about 5 to about 150, preferably from about 7 to about 100 and each R² is the same or different and is selected from the group consisting of hydrogen, an alkyl having 1 to 4 carbon atoms, and an acetyl group, preferably hydrogen and/or methyl group. Each polyalkylene oxide polysiloxane has at least one R¹ group being a poly(ethyleneoxide/propyleneoxide) copolymer group.

Nonlimiting examples of these silicone polyethers are the Silwet® materials which are available from GE Silicones. Representative Silwet® silicone polyethers which contain only ethyleneoxy (C2H4O) groups are as follows:

| Name | Average MW | Average a + b | Average total c |
|---|---|---|---|
| L-7608 | 600 | 1 | 8 |
| L-7607 | 1,000 | 2 | 17 |
| L-77 | 600 | 1 | 9 |
| L-7605 | 6,000 | 20 | 99 |
| L-7604 | 4,000 | 21 | 53 |
| L-7600 | 4,000 | 11 | 68 |
| L-7657 | 5,000 | 20 | 76 |
| L-7602 | 3,000 | 20 | 29 |
| L-7622 | 10,000 | 88 | |
| L-8600 | 2,100 | | |
| L-8610 | 1,700 | | |
| L-862 | 2,000 | | |

Nonlimiting examples of Silwet® silicone polyethers which contain both ethyleneoxy (C2H4O) and propyleneoxy (C3H6O) groups are as follows:

| Name | Average MW | EO/PO ratio |
|---|---|---|
| L-720 | 12,000 | 50/50 |
| L-7001 | 20,000 | 40/60 |
| L-7002 | 8,000 | 50/50 |
| L-7210 | 13,000 | 20/80 |
| L-7200 | 19,000 | 75/25 |
| L-7220 | 17,000 | 20/80 |

Nonlimiting examples of Silwet® silicone polyethers which contain only propyleneoxy (C3H6O) groups are as follows:

| Name | Average MW |
|---|---|
| L7500 | 3,000 |
| L7510 | 13,000 |
| L7550 | 300′ |
| L8500 | 2,800 |

The molecular weight of the polyalkyleneoxy group (R1) preferably is less than or equal to about 10,000. The preferred molecular weight of the silicone polyether is dependent on the exact functionality in a given composition. If propyleneoxy groups are present in the polyalkyleneoxy chain, they can be distributed randomly in the chain or exist as blocks. Preferred Silwets® aid in color restoration when included in the composition in a sufficient concentration and can also provide softness, which is especially preferred when a silicone polymer leaves a rough feeling on the surface of the fabric. Nonlimiting examples of preferred Silwets® include L77, L7001, L7200, L7087 and, particularly, L-7600. Some nonlimiting preferred Dow Corning® silicone polyethers include Dow Coming® DC Q2-5247, (dimethyl, methylhydroxypropyl, ethoxylated propoxylated siloxane, primarily [CAS# 68937-55-3] comprised of siloxane, EO, and PO. Other nonlimiting examples of silicone polyethers useful in the present invention include the following compounds available from Dow Coming® 193, 112, 8600, FF-400 Fluid, Q2-5220, Q4-3667, PP 5495, as well as compounds available from Toray Dow Coming Silicone Co., Ltd. know as SH3771C, SH3772C, SH3773C, SH3746, SH3748, SH3749, SH8400, SF8410, and SH8700, KF351 (A), KF352 (A), KF354 (A), and KF615 (A) of Shin-Etsu Chemical Co., Ltd., TSF4440, TSF4445, TSF4446, TSF4452 of Toshiba Silicone Co. Another nonlimiting example is SLM 21200 from Wacker.

Some silicone polyethers (especially the more hydrophobic versions) may require additional emulsifying agents to make a stable spray composition. Such emulsifying agents are typically anionic, nonionic, cationic, amphoteric, or zwitterionic surfactants or mixtures thereof. Typically emulsifying agents and surfactants can also act as spreading agents on the fabric to spread out active ingredients such as the silicone polymers.

When an optional static friction increasing agent, e.g., cyclodextrin, is used to increase the coefficient of static friction, it is preferred to use silicone polyethers with higher molecular weights, at least about 5,000, preferably at least about 10,000, more preferably at least about 15,000, and most preferably at least about 20,000. Solvent, e.g., ethanol, levels can be increased to at least about 4% by weight, preferably at least about 5%, more preferably at least about 7% and most preferably at least about 9% by weight.

Another embodiment of the present invention is a low solvent composition having from 0% to about 3% volatile solvents including ethanol. These low volatile solvent compositions can be especially desirable if the method of use of the composition is for addition to a machine dryer.

Besides color restoration, silicone polyethers can also provide other benefits, such as antistatic benefits, lubricity, improved smoothness, reduction of fabric wear such as pilling, and softness feel to fabrics.

The preparation of silicone polyethers is well know in the art. Silicone polyethers suitable for use in the present invention can be prepared according to the procedure set forth in U.S. Pat. No. 3,299,112. Typically, silicone polyethers suitable for use in the present invention are readily prepared by an addition reaction between a hydrosiloxane (i.e., a siloxane containing silicon-bonded hydrogen) and an alkenyl ether (e.g., a vinyl, allyl, or methallyl ether of an alkoxy or hydroxyl end-blocked polyalkylene oxide). The reaction conditions employed in addition reactions of this type are well known in the art and in generally involve heating the reactants (e.g., at a temperature of from about 85° C. to 1 10° C.) in the present of a platinum catalyst (e.g., chloroplatinic acid) and a solvent (e.g., toluene).

Other nonlimiting silicone compounds and emulsions useful as color restoration agents of the compositions described herein include non-curable silicones (such as, but not limited to, volatile silicones, silicone oils, and polydimethyl silicones) and curable silicones (such as, but not limited to, aminosilicones, phenylsilicones, and hydroxysilicones). Also useful in the present compositions are silicone emulsions that comprise silicone oils such as 346 Emulsion, 347 Emulsion, and HV-490 available from Dow Corning. Specifically, the preferred silicone oil is dimethylsiloxane silicone, more preferably volatile dimethylsiloxane.

Preferred silicones are neither irritating, toxic, nor otherwise harmful when applied to fabric or when they come in contact with human skin, and are chemically stable under normal use and storage conditions.

When the compositions described herein are to be dispensed from a spray dispenser in a consumer household setting, the noncurable silicones such as the silicone polyethers or polydimethylsilicones, are preferred.

Another useful color restoration silicone is volatile silicone fluid which can be a cyclic fluid of the formula [(CH3)2SiO]ₙ, where n ranges between about 3 to about 7, preferably about 5, or a linear silicone polymer fluid having the formula (CH3)3SiO[(CH3)2SiO]ₘ, where m can be 0 or greater and has an average value such that the viscosity at 25° C. of the silicone fluid is preferably about 5 centistokes (cSt) or less.

The non-volatile silicones that are useful in the composition of the present invention are polyalkyl and/or phenylsilicones silicone fluids and gums with the following structure:

A-Si(R₂)O Si(R₂) O ]_{q}—Si(R₂)-A

The alkyl groups substituted on the siloxane chain (R) or at the ends of the siloxane chains (A) can have any structure as long as the resulting silicones remain fluid at room temperature.

Each R group preferably can be alkyl, aryl, hydroxy, or hydroxyalkyl group, and mixtures thereof, more preferably, each R is methyl, ethyl, propyl or phenyl group, most preferably R is methyl. Each A group which blocks the ends of the silicone chain can be hydrogen, methyl, methoxy, ethoxy, hydroxyl, propoxy, and aryloxy group, preferably methyl. Suitable A groups include hydrogen, methyl, methoxy, ethoxy, hydroxyl, and propoxy. Q is preferably an integer from about 7 to about 8,000. The preferred silicones are polydimethyl siloxanes; more preferred silicones are polydimethyl siloxanes having a viscosity of from about 50 to about 1,000,000 centistokes at 25° C. Mixtures of volatile silicones and non-volatile polydimethyl siloxanes are also preferred. Suitable examples include silicones offered by Dow Coming Corporation under the trade names 200 Fluid and 245 Fluid, and the General Electric Company under the trade names SF1173, SF1202, SF1204, SF96, and Viscasil®.

Other useful silicone materials, but less preferred than the silicone polyethers or the polydimethylsiloxanes, include materials of the formula:

HO—[Si(CH₃)₂—O]ₓ—{Si(OH)[(CH₂)₃—NH—(CH₂)₂—NH₂]O}_{y}—H

wherein x and y are integers which depend on the molecular weight of the silicone, preferably having a viscosity of from about 10,000 cSt to about 500,000 cSt at 25° C. This material is also known as “amodimethicone”. Although silicones with a high number, e.g., greater than about 0.5 millimolar equivalent, of amine groups can be used, they are not preferred because they can cause fabric yellowing.

Similarly, silicone materials which can be used correspond to the formulas:

(R¹)ₐG₃₋ₐ-Si—(—OSiG₂)ₙ—OSiG_{b}(R¹)_{2-b})ₘ—O—SiG₃₋ₐ(R¹)ₐ

wherein G is selected from the group consisting of hydrogen, phenyl, OH, and/or C₁-C₈ alkyl; a denotes 0 or an integer from 1 to 3; b denotes 0 or 1; the sum of n+m is a number from 1 to about 2,000; R¹ is a monovalent radical of formula CₚH₂ₚL in which p is an integer from 2 to 8 and L is selected from the group consisting of:

—N(R²)CH₂—CH₂—N(R² )₂;

—N(R²)₂;

—N⁺(R²)₃A⁻; and

N⁺(R²)CH₂—H₂N⁺H₂ A⁺

wherein each R2 is chosen from the group consisting of hydrogen, phenyl, benzyl, saturated hydrocarbon radical, and each A-denotes compatible anion, e.g., a halide ion; and

R³—N⁺(CH₃)₂-Z-[Si(CH₃)₂O]_{f}—si(CH₃)₂-Z-N⁺(CH₃)₂—R³.2CH₃COO—

wherein

Z=—CH₂—CH(OH)—CH₂O—CH₂)₃—

R³ denotes a long chain alkyl group; and
f denotes an integer of at least about 2.

In the formulas herein, each definition is applied individually and averages are included.

Another silicone material which can be used, but is less preferred than the silicone polyethers or the polydimethyl siloxanes (PDMS), has a formula:

(CH₃)₃Si—[O—Si(CH₃)₂]ₙ—{OSi(CH₃)[(CH₂)₃—NH—(CH₂)₂—NH₂]}ₘ—OSi(CH₃)₃

wherein n and m are the same as before. The preferred silicones of this type are those which do not cause fabric discoloration.
Phenyl silicones may be used as well and in combination with other silicone polymers, especially if higher levels of silicone are desired in the color restoration compositions, even above 10%.

Mixtures of silicone are also preferred to achieve a range of properties within one composition. And in some aspects of the invention, mixtures of silicones are highly useful. For instance, when silicone oils such as PDMS are used, these can be very difficult to emulsify. Silicone polyethers provide an effective means of solubilizing silicone oils.

### Optional Ingredients

### Static Friction-Increasing Agent

As discussed before, the compositions described herein, preferably containing at least about 1.75% by weight silicone polymer, can result in a hazardous, slippery floor when cured and/or bonded to flooring surfaces. It is therefore preferred, but not essential, that the compositions described herein contain one or more coefficient of static friction increasing agents to reduce or eliminate the slippery floor hazard. Preferably the compositions described herein contain a static friction-increasing agent in an effective amount such that the cured, dry composition has a static coefficient of friction of at least about 0.4, preferably at least about 0.5, using the COF Test method. Exemplary anti-slip agents include polysaccharides; starches; starch derivatives; sugar; sugar derivatives; polyacrylates; cyclodextrins; and lecithin and its derivatives disclosed in U.S. Pat. No. 5,356,466; or mixtures of any of the foregoing. The preferred anti-slip agents are cyclodextrins, polysaccharides, and polyacrylates. The most preferred anti-slip agent is hydroxypropyl β cyclodextrin. The optional anti-slip agent is incorporated into the composition in an amount of about 0.1% to about 5.0% by weight of the composition, preferably about 1% to about 4%, more preferably about 1.5% to about 3% by weight. Preferably a minimal level of the static friction-increasing agents, included in the preferred compositions described herein is at least about 0.9% by weight, based on the total weight of the composition, preferably at least about 1.0% by weight. The weight ratio of silicone polymer to anti-slip agent or mixture of anti-slip agents is from about 1.5 to about 5, preferably from about 2 to about 4.5.

### Surfactant

A surfactant is an optional, but highly preferred, ingredient of the present invention. The surfactant is especially useful in the composition to facilitate the dispersion and/or solubilization of color restoration agents such as silicones and/or certain relatively water insoluble shape retention polymers and to improve active spreading on the fabric. The surfactant can provide some plasticizing effect to the shape retention polymers resulting in a more flexible polymer network. The surfactant can provide a low surface tension that permits the composition to spread readily and more uniformly on hydrophobic surfaces like polyester and nylon fabrics. Such surfactant is preferably included when the composition is used in a spray dispenser in order to enhance the spray characteristics of the composition and allow the composition to distribute more evenly, and to prevent clogging of the spray apparatus. The spreading of the composition can also allow it to dry faster, so that the treated material is ready to use sooner. For concentrated compositions, the surfactant facilitates the dispersion of many actives such as antimicrobial actives and perfumes in the concentrated aqueous compositions. Suitable surfactants useful in the present invention include nonionic surfactants, anionic surfactants, cationic surfactants, amphoteric surfactants, and mixtures thereof. When a surfactant is used in the composition of the present invention, it is added at an effective amount to provide one, or more of the benefits described herein, typically from about 0.01% to about 5%, preferably from about 0.05% to about 3%, more preferably from about 0.1% to about 2%, and even more preferably, from about 0.2% to about 1%, by weight of the composition.

A preferred type of surfactant is an ethoxylated surfactant, such as addition products of ethylene oxide with fatty alcohols, fatty acids, fatty amines, etc. Optionally, addition products of mixtures of ethylene oxide and propylene oxide with fatty alcohols, fatty acids, fatty amines may be used. The,ethoxylated surfactant includes compounds having the general formula:

R⁸-Z-(CH₂CH₂O)₅B

wherein R⁸ is an alkyl group or an alkyl aryl group, selected from the group consisting of primary, secondary and branched chain alkyl hydrocarbyl groups, primary, secondary and branched chain alkenyl hydrocarbyl groups, and/or primary, secondary and branched chain alkyl- and alkenyl-substituted phenolic hydrocarbyl groups having from about 6 to about 20 carbon atoms, preferably from about 8 to about 18, more preferably from about 10 to about 15 carbon atoms; s is an integer from about 2 to about 45, preferably from about 2 to about 20, more preferably from about 2 to about 15; B is a hydrogen, a carboxylate group, or a sulfate group; and linking group Z is —O—, —C(O)O—, —C(O)N(R)—, or —C(O)N(R)—, and mixtures thereof, in which R, when present, is R⁸ or hydrogen.

The nonionic surfactants herein are characterized by an HLB (hydrophilic lipophilic balance) of from 5 to 20, preferably from 6 to 15.

Nonlimiting examples of preferred ethoxylated surfactant are:
straight-chain, primary alcohol ethoxylates, with R⁸ being C₈-C₁₈ alkyl and/or alkenyl group, more preferably C₁₀-C₁₄, and s being from about 2 to about 8, preferably from about 2 to about 6;
straight-chain, secondary alcohol ethoxylates, with R⁸ being C₈-C₁₈ alkyl and/or alkenyl, e.g., 3-hexadecyl, 2-octadecyl, 4-eicosanyl, and 5-eicosanyl, and s being from about 2 to about 10;
alkyl phenol ethoxylates wherein the alkyl phenols having an alkyl or alkenyl group containing from 3 to 20 carbon atoms in a primary, secondary or branched chain configuration, preferably from 6 to 12 carbon atoms, and s is from about 2 to about 12, preferably from about 2 to about 8;
branched chain alcohol ethoxylates, wherein branched chain primary and secondary alcohols (or Guerbet alcohols) which are available, e.g., from the well-known “OXO” process or modification thereof are ethoxylated.

Especially preferred are alkyl ethoxylate surfactants with each R8 being C8-C16 straight chain and/or branch chain alkyl and the number of ethyleneoxy groups s being from about 2 to about 6, preferably from about 2 to about 4, more preferably with R8 being C8-C15 alkyl and s being from about 2.25 to about 3.5. These nonionic surfactants are characterized by an HLB of from 6 to about 11, preferably from about 6.5 to about 9.5, and more preferably from about 7 to about 9. Nonlimiting examples of commercially available preferred surfactants are Neodol 91-2.5 (C9-C10, s=2.7, HLB=8.5), Neodol 23-3 (C12-C13, s=2.9, HLB=7.9) and Neodol 25-3 (C12-C15, s=2.8, HLB=7.5). It has been found, very surprisingly, that these preferred surfactants, which are themselves not very water soluble (0.1% aqueous solutions of these surfactants are not clear), can at low levels, effectively dissolve and/or disperse shape retention polymers such as copolymers containing acrylic acid and tert-butyl acrylate and silicone-containing copolymers into clear compositions, even without the presence of a low molecular weight alcohol.

Also preferred is a nonionic surfactant selected from the group consisting of fatty acid (C12-18) esters of ethoxylated (EO₅₋₅₀) sorbitans. More preferably said surfactant is selected from the group consisting of mixtures of laurate esters of sorbitol and sorbitol anhydrides; mixtures of stearate esters of sorbitol and sorbitol anhydrides; and mixtures of oleate esters of sorbitol and sorbitol anhydrides. Even more preferably said surfactant is selected from the group consisting of Polysorbate 20, which is a mixture of laurate esters of sorbitol and sorbitol anhydrides consisting predominantly of the monoester, condensed with about 20 moles of ethylene oxide; Polysorbate 60, which is a mixture of stearate esters of sorbitol and sorbitol anhydride, consisting predominantly of the monoester, condensed with about 20 moles of ethylene oxide; Polysorbate 80, which is a mixture of oleate esters of sorbitol and sorbitol anhydrides, consisting predominantly of the monoester, condensed with about 20 moles of ethylene oxide; and mixtures thereof. Most preferably, said surfactant is Polysorbate 60.

Other examples of preferred ethoxylated surfactant include carboxylated alcohol ethoxylate, also known as ether carboxylate, with R⁸ having from about 12 to about 16 carbon atoms, and s being from about 5 to about 13; ethoxylated quaternary ammonium surfactants, such as PEG-5 cocomonium methosulfate, PEG-15 cocomonium chloride, PEG-15 oleammonium chloride and bis(polyethoxyethanol)tallow ammonium chloride.

Other suitable nonionic ethoxylated surfactants are ethoxylated alkyl amines derived from the condensation of ethylene oxide with hydrophobic alkyl amines, with R8 having from about 8 to about 22 carbon atoms and s being from about 3 to about 30.

Other useful silicone surfactants are those having a hydrophobic moiety and hydrophilic ionic groups, including, e.g., anionic, cationic, and amphoteric groups. Nonlimiting examples of anionic silicone surfactants are silicone sulfosuccinates, silicone sulfates, silicone phosphates, silicone carboxylates, and mixtures thereof, as disclosed respectively in U.S. Pat. Nos, 4,717,498, 4,960,845, 5,149,765, and 5,296,434. Nonlimiting examples of cationic silicone surfactants are silicone alkyl quats (quaternary ammoniurns), silicone amido quats, silicone imidazoline quats, and mixtures thereof, as disclosed respectively in U.S. Pat. Nos. 5,098,979, 5,135,294, and 5,196,499. Nonlimiting examples of amphoteric silicone surfactants are silicone betaines, silicone amino proprionates, silicone phosphobetaines, and mixtures thereof, as disclosed respectively in U˜S. Pat. Nos. 4,654,161, 5,073,619, and 5,237,035.

### Cyclodextrin-Compatible Surfactant

When the optional cyclodextrin is present, the surfactant for use in providing the required low surface tension in the composition of the present invention should he cyclodextrin-compatible, that is it should not substantially form a complex with the cyclodextrin so as to diminish performance of the cyclodextrin and/or the surfactant when cyclodextrin is present. Complex formation diminishes both the ability of the cyclodextrin to absorb odors and the ability of the surfactant to lower the surface tension of the aqueous composition.

Suitable cyclodextrin-compatible surfactants can be readily identified by the absence of effect of cyclodextrin on the surface tension provided by the surfactant. This is achieved by determining the surface tension (in dyne/cm2) of aqueous solutions of the surfactant in the presence and in the absence of about 1% of a specific cyclodextrin in the solutions. The aqueous solutions contain surfactant at concentrations of approximately 0.5%, 0.1%, 0.01%, and 0.005%. The cyclodextrin can affect the surface activity of a surfactant by elevating the surface tension of the surfactant solution. If the surface tension at a given concentration in water differs by more than about 10% from the surface tension of the same surfactant in the 1% solution of the cyclodextrin, that is an indication of a strong interaction between the surfactant and the cyclodextrin. The preferred surfactants herein should have a surface tension in an aqueous solution that is different (lower) by less than about 10%, preferably less than about 5%, and more preferably less than about 1% from that of the same concentration solution containing 1% cyclodextrin.

Nonlimiting examples of cyclodextrin-compatible nonionic surfactants include block copolymers of ethylene oxide and propylene oxide. Suitable block polyoxyethylene-polyoxypropylene polymeric surfactants, that are compatible with most cyclodextrins, include those based on ethylene glycol, propylene glycol, glycerol, trimethylolpropane and ethylenediamine as the initial reactive hydrogen compound. Polymeric compounds made from a sequential ethoxylation and propoxylation of initial compounds with a single reactive hydrogen atom, such as C12-18 aliphatic alcohols, are not generally compatible with the cyclodextrin. Certain of the block polymer surfactant compounds designated Pluronic® and Tetronic® by the BASF-Wyandotte Corp., Wyandotte, Mich., are readily available.

Nonlimiting examples of cyclodextrin-compatible surfactants of this type include:
Pluronic Surfactants with the general formula H(EO)ₙ(PO)ₘ(EO)ₙH, wherein EO is an ethylene oxide group, PO is a propylene oxide group, and n and m are numbers that indicate the average number of the groups in the surfactants. Typical examples of cyclodextrin-compatible Pluronic surfactants are:

| Name | Average MW | Average n | Average m |
|---|---|---|---|
| L-101 | 3,800 | 4 | 59 |
| L-81 | 2,750 | 3 | 42 |
| L-44 | 2,200 | 10 | 23 |
| L-43 | 1,850 | 6 | 22 |
| F-38 | 4,700 | 43 | 16 |
| P-84 | 4,200 | 19 | 43, |

and mixtures thereof.
Tetronic Surfactants with the general formula:

[H(EO)ₙ(PO)ₘ]₂NCH₂CH₂N[(PO)ₘ(EO)ₙH]₂

wherein EO, PO, n, and m have the same meanings as above. Typical examples of cyclodextrin-compatible Tetronic surfactants are:

| Name | Average MW | Average n | Average m |
|---|---|---|---|
| 901 | 4,700 | 3 | 18 |
| 908 | 25,000 | 114 | 22, |

and mixtures thereof.

“Reverse” Pluronic and Tetronic surfactants have the following general formulas:
Reverse Pluronic Surfactants

H(PO)ₘ(EO)ₙ(PO)ₘH
Reverse Tetronic Surfactants

[H(PO)ₙ(EO)ₘ]₂NCH₂CH₂N[(EO)ₘ(PO)ₙH]₂

wherein EO, PO, n, and m have the same meanings as above. Typical examples of cyclodextrin-compatible Reverse Pluronic and Reverse Tetronic surfactants are:
Reverse Pluronic surfactants:

| Name | Average MW | Average n | Average m |
|---|---|---|---|
| 10 R5 | 1,950 | 8 | 22 |
| 25 R1 | 2,700 | 21 | 6 |

Reverse Tetronic surfactants

| Name | Average MW | Average n | Average m |
|---|---|---|---|
| 130 R2 | 7,740 | 9 | 26 |
| 70 R2 | 3,870 | 4 | 13 |

and mixtures thereof.

A preferred class of cyclodextrin-compatible nonionic surfactants are the polyalkylene oxide polysiloxanes, as described herein above.

Nonlimiting examples of cyclodextrin-compatible anionic surfactants are the alkyidiphenyl oxide disulfonate, having the general formula:

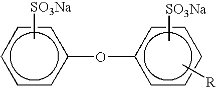

wherein R is an alkyl group. Examples of this type of surfactants are available from the Dow Chemical Company under the trade name Dowfax® wherein R is a linear or branched C₆-C₁₆ alkyl group. An example of these cyclodextrin-compatible anionic surfactant is Dowfax 3B2 with R being approximately a linear C₁₀ group. These anionic surfactants are preferably not used when the antimicrobial active or preservative, etc., is cationic to minimize the interaction with the cationic actives, since the effect of both surfactant and active are diminished.

The surfactants above are either weakly interactive with cyclodextrin (less than 5% elevation in surface tension, or non-interactive (less than 1% elevation in surface tension). Normal surfactants like sodium dodecyl sulfate and dodecanolpoly(6)ethoxylate are strongly interactive, with more than a 10% elevation in surface tension in the presence of a typical cyclodextrin like hydroxypropyl-beta cyclodextrin and methylated beta-cyclodextrin.

Typical levels of cyclodextrin-compatible surfactants in the compositions of the present invention are from about 0.01% to about 2%, preferably from about 0.03% to about 0.6%, more preferably from about 0.05% to about 0.3%, by weight of the composition. Typical levels of cyclodextrin-compatible surfactants in concentrated compositions are from about 0.1% to about 8%, preferably from about 0.2% to about 4%, more preferably from about 0.3% to about 3%, by weight of the concentrated composition.

### Optional Odor Control Agent

The compositions for odor control are of the type disclosed in U.S. Pat. Nos. 5,534,165; 5,578,563; 5,663,134; 5,668,097; 5,670,475; and 5,714,137. Such compositions can contain several different optional odor control agents in addition to the polymers described hereinbefore that can control amine odors.

### Cyclodextrin

As used herein, the term “cyclodextrin” includes any of the known cyclodextrins such as unsubstituted cyclodextrins containing from six to twelve glucose units, especially, alpha-cyclodextrin, beta-cyclodextrin, gamma-cyclodextrin and/or their derivatives and/or mixtures thereof. The alpha-cyclodextrin consists of six glucose units, the beta-cyclodextrin consists of seven glucose units, and the gamma-cyclodextrin consists of eight glucose units arranged in donut-shaped rings. The specific coupling and conformation of the glucose units give the cyclodextrins a rigid, conical molecular structures with hollow interiors of specific volumes. The unique shape and physical-chemical properties of the cavity enable the cyclodextrin molecules to absorb (form inclusion complexes with) organic molecules or parts of organic molecules which can fit into the cavity. Many odorous molecules can fit into the cavity including many malodorous molecules and perfume molecules. Therefore, cyclodextrins, and especially mixtures of cyclodextrins with different size cavities, can be used to control odors caused by a broad spectrum of organic odoriferous materials, which may contain reactive functional groups. The complexation between cyclodextrin and odorous molecules occurs rapidly in the presence of water. However, the extent of the complex formation also depends on the polarity of the absorbed molecules. In an aqueous solution, strongly hydrophilic molecules (those which are highly water-soluble) are only partially absorbed, if at all. Therefore, cyclodextrin does not complex effectively with some very low molecular weight organic amines and acids when they are present at low levels on wet fabrics. As the water is being removed however, e.g., the fabric is being dried off, some low molecular weight organic amines and acids have more affinity and will complex with the cyclodextrins more readily.

The cavities within the cyclodextrin in the solution compositions described herein should remain essentially unfilled (the cyclodextrin remains uncomplexed) while in solution, in order to allow the cyclodextrin to absorb various odor molecules when the solution is applied to a surface. Non-derivatised (normal) beta-cyclodextrin can be present at a level up to its solubility limit of about 1.85% (about 1.85g in 100 grams of water) at room temperature. Beta-cyclodextrin is not preferred in compositions which call for a level of cyclodextrin higher than its water solubility limit. Non-derivatised beta-cyclodextrin is generally not preferred when the composition contains surfactant since it affects the surface activity of most of the preferred surfactants that are compatible with the derivatised cyclodextrins.

Preferably, the odor absorbing solution of the compositions described herein is clear. The term “clear” as defined herein means transparent or translucent, preferably transparent, as in “water clear,” when observed through a layer having a thickness of less than about 10 cm.

Preferably, any cyclodextrin(s) used in the color restoring compositions are highly water-soluble such as, alpha-cyclodextrin and/or derivatives thereof, gamma-cyclodextrin and/or derivatives thereof derivatised beta-cyclodextrins, and/or mixtures thereof. The derivatives of cyclodextrin-consist mainly of molecules wherein some of the OH groups are converted to OR groups. Cyclodextrin derivatives include, e.g., those with short chain alkyl groups such as methylated cyclodextrins, and ethylated cyclodextrins, wherein R is a methyl or an ethyl group; those with hydroxyalkyl substituted groups, such as hydroxypropyl cyclodextrins and/or hydroxyethyl cyclodextrins, wherein R is a —CH7—CH(OH)—CH3 or a CH2CH2—OH group; branched cyclodextrins such as maltose-bonded cyclodextrins; cationic cyclodextrins such as those containing 2-hydroxy-3-(dimethylamino)propyl ether, wherein R is CH2—CH(OH)—CH2—N(CH3)2 which is cationic at low pH; quaternary ammonium, e.g., 2-hydroxy-3-(trimethylammonio)propyl ether chloride groups, wherein R is CH2—CH(OH)—CH2—N+(CH3)3Cl—; anionic cyclodextrins such as carboxymethyl cyclodextrins, cyclodextrin sulfates, and cyclodextrin succinylates; amphoteric cyclodextrins such as carboxymethyl/quaternary ammonium cyclodextrins; cyclodextrins wherein at least one glucopyranose unit has a 3-6-anhydro-cyciomalto structure, e.g., the mono-3-6-anhydrocyclodextrins, as disclosed in “Optimal Performances with Minimal Chemical Modification of Cyclodextrins”, F. Diedaini-Pilard and B. Perly, The 7th International Cyclodextrin Symposium Abstracts, April 1994, p. 49; and mixtures thereof. Other cyclodextrin derivatives are disclosed in U.S. Pat. No. 3,426,011, Parmerter et al., issued Feb. 4, 1969; U.S. Pat. Nos. 3,453,257; 3,453,258; 3,453,259; and 3,453,260, all in the names of Parmerter et al., and all issued Jul. 1, 1969; U.S. Pat. No. 3,459,731, Gramera et al., issued Aug. 5, 1969; U.S. Pat. No. 3,553,191, Parmerter et al., issued Jan. 5, 1971; U.S. Pat. No.3,565,887, Parmerter et al., issued Feb. 23, 1971; U.S. Pat. No. 4,535,152, Szejtli et al., issued Aug. 13, 1985; U.S. Pat. No. 4,616,008, Hirai et al., issued Oct. 7, 1986; U.S. Pat. No. 4,678,598, Ogino et al., issued Jul. 7, 1987; U.S. Pat. No. 4,638,058, Brandt et al., issued Jan. 20, 1987; and U.S. Pat. No. 4,746,734, Tsuchiyama et al., issued May 24, 1988.

Highly water-soluble cyclodextrins are those having water solubility of at least about 10 g in 100 ml of water at room temperature, preferably at least about 20 g in 100 ml of water, more preferably at least about 25 g in 100 ml of water at room temperature. The availability of solubilized, uncomplexed cyclodextrins is essential for effective and efficient odor control performance. Solubilized, water-soluble cyclodextrin can exhibit more efficient odor control performance than non-water-soluble cyclodextrin when deposited onto surfaces, especially fabric.

Examples of preferred water-soluble cyclodextrin derivatives suitable for use herein are hydroxypropyl alpha-cyclodextrin, methylated alpha-cyclodextrin, methylated beta-cyclodextrin, hydroxyethyl beta-cyclodextrin, and hydroxypropyl β-cyclodextrin. Hydroxyalkyl cyclodextrin derivatives preferably have a degree of substitution of from about 1 to about 14, more preferably from about 1.5 to about 7, wherein the total number of OR groups per cyclodextrin is defined as the degree of substitution. Methylated cyclodextrin derivatives typically have a degree of substitution of from about 1 to about 18, preferably from about 3 to about 16. A known methylated beta-cyclodextrin is heptakis-2,6-di-O-methyl-β-cyclodextrin, commonly known as DIMEB, in which each glucose unit has about 2 methyl groups with a degree of substitution of about 14. A preferred, more commercially available, methylated beta-cyclodextrin is a randomly methylated beta-cyclodextrin, commonly known as RAMEB, having different degrees of substitution, normally of about 12.6. RAMEB is more preferred than DIMEB, since DIMEB affects the surface activity of the preferred surfactants more than RAMEB. The preferred cyclodextrins are available, e.g. from Cerestar USA, Inc. and Wacker Chemicals (USA), Inc.

It is also preferable to use a mixture of cyclodextrins. Such mixtures absorb odors more broadly by complexing with a wider range of odoriferous molecules having a wider range of molecular sizes. Preferably at least a portion of the cyclodextrins is alpha-cyclodextrin and its derivatives thereof, gamma-cyclodextrin and its derivatives thereof, and/or derivatised beta-cyclodextrin, more preferably a mixture of alpha-cyclodextrin, or an alpha-cyclodextrin derivative, and derivatised beta-cyclodextrin, even more preferably a mixture of derivatised alpha-cyclodextrin n and derivatised beta-cyclodextrin, most preferably a mixture of hydroxypropyl alpha-cyclodextrin and hydroxypropyl beta-cyclodextrin, and/or a mixture of methylated alpha-cyclodextrin and methylated beta-cyclodextrin.

For controlling odor on fabrics, the composition is preferably used as a spray. It is preferable that the usage compositions of the present invention contain low levels of cyclodextrin so that a visible stain does not appear on the fabric at normal usage levels. Preferably, the solution used to treat the surface under usage conditions is virtually not discernible when dry. Typical levels of cyclodextrin in usage compositions for usage conditions are from about 0.01% to about 5%, preferably from about 0.1% to about 4%, more preferably from about 0.5% to about 2% by weight of the composition. Compositions with higher concentrations can leave unacceptable visible stains on fabrics as the solution evaporates off of the fabric. This is especially a problem on thin, colored, synthetic fabrics, in order to avoid or minimize the occurrence of fabric staining, it is preferable that the fabric be treated at a level of less than about 5 mg of cyclodextrin per gram of fabric, more preferably less than about 2 mg of cyclodextrin per gram of fabric. The presence of the surfactant can improve appearance by minimizing localized spotting.

Concentrated compositions can also be used in order to deliver a less expensive product. When a concentrated product is used, i.e., when the level of cyclodextrin used is from about 3% to about 20%, more preferably from about 5% to about 10%, by weight of the concentrated composition, it is preferable to dilute the concentrated composition before treating fabrics in order to avoid staining. Preferably the concentrated cyclodextrin composition is diluted with about 50% to about 6000%, more preferably with about 75% to about 2000%, most preferably with about 100% to about 1000% by weight of the concentrated composition of water. The resulting diluted compositions have usage concentrations of cyclodextrin as discussed hereinbefore, e.g., of from about 0.1% to about 5%, by weight of the diluted composition.

### Low Molecular Weight Polyols

Low molecular weight polyols with relatively high boiling points, as compared to water, such as ethylene glycol, propylene glycol and/or glycerol are preferred optional ingredients for improving odor control performance of the composition of the present invention when cyclodextrin is present. Not to be bound by theory, it is believed that the incorporation of a small amount of low molecular weight glycols into the composition of the present invention enhances the formation of the cyclodextrin inclusion complexes as the fabric dries.

It is believed that the polyols' ability to remain on the fabric for a longer period of time than water, as the fabric dries allows it to form ternary complexes with the cyclodextrin and some malodorous molecules. The addition of the glycols is believed to fill up void space in the cyclodextrin cavity that is unable to be filled by some malodor molecules of relatively smaller sizes. Preferably the glycol used is glycerin, ethylene glycol, propylene glycol, diethylene glycol, dipropylene glycol or mixtures thereof, more preferably ethylene glycol and/or propylene glycol. Cyclodextrins prepared by processes that result in a level of such polyols are highly desirable, since they can be used without removal of the polyols.

Some polyols, e.g., dipropylene glycol, are also useful to facilitate the solubilization of some perfume ingredients in the composition of the present invention.

Typically, glycol is added to the composition of the present invention at a level of from about 0.01% to about 3%, by weight of the composition, preferably from about 0.05% to about 1%, more preferably from about 0.1% to about 0.5%, by weight of the composition. The preferred weight ratio of low molecular weight polyol to cyclodextrin is from about 2:1,000 to about 20:100, more preferably from about 3:1,000 to about 15:100, even more preferably from about 5:1,000 to about 10:100, and most preferably from about 1:100 to about 7:100.

### Metal Salts

Optionally, but highly preferred, the present invention can include metallic salts for added odor absorption and/or antimicrobial benefit for the cyclodextrin solution when cyclodextrin is present. The metallic salts are selected from the group consisting of copper salts, zinc salts, and mixtures thereof

Copper salts have some antimicrobial benefits. Specifically, cupric abietate acts as a fungicide, copper acetate acts as a mildew inhibitor, cupric chloride acts as a fungicide, copper lactate acts as a fungicide, and copper sulfate acts as a germicide. Copper salts also possess some malodor control abilities. See U.S. Pat. No. 3,172,817, Leupold, et al., which discloses deodorizing compositions for treating disposable articles, comprising at least slightly water-soluble salts of acylacetone, including copper salts and zinc salts.

The preferred zinc salts possess malodor control abilities. Zinc has been used most often for its ability to ameliorate malodor, e.g., in mouth wash products, as disclosed in U.S. Pat. No. 4,325,939, issued Apr. 20, 1982 and U.S. Pat. No. 4,469,674, issued Sept. 4, 1983, to N. B. Shah, et al. Highly-ionized and soluble zinc salts such as zinc chloride, provide the best source of zinc ions. Zinc borate functions as a fungistat and a mildew inhibitor, zinc caprylate functions as a fungicide, zinc chloride provides antiseptic and deodorant benefits, zinc ricinoleate functions as a fungicide and odor control agent, zinc sulfate heptahydrate functions as a fungicide and zinc undecylenate functions as a fungistat.

Preferably the metallic salts are water-soluble zinc salts, copper salts or mixtures thereof, and more preferably zinc salts, especially ZnCl2, These salts are preferably present in the present invention primarily to absorb amine and sulfur-containing compounds that have molecular sizes too small to be effectively complexed with the cyclodextrin molecules. Low molecular weight sulfur-containing materials, e.g., sulfide and mercaptans, are components of many types of malodors, e.g., food odors (garlic, onion), body/perspiration odor, breath odor, etc. Low molecular weight amines arc also components of many malodors, e.g., food odors, body odors, urine, etc.

When metallic salts are added to the composition of the present invention they are typically present at a level of from about 0. 1% to about 10%, preferably from about 0.2% to about 8%, more preferably from about 0.3% to about 5% by weight of the usage composition. When zinc salts are used as the metallic salt, and a clear solution is desired, it is preferable that the pH of the solution is adjusted to less than about 7, more preferably less than about 6, most preferably, less than about 5, in order to keep the solution clear.

Soluble Carbonate and/or Bicarbonate Salts

Water-soluble alkali metal carbonate and/or bicarbonate salts, such as sodium bicarbonate, potassium bicarbonate, potassium carbonate, cesium carbonate, sodium carbonate, and mixtures thereof can be added to the composition of the present invention in order to help to control certain acid-type odors. Preferred salts are sodium carbonate monohydrate, potassium carbonate, sodium bicarbonate, potassium bicarbonate, and mixtures thereof When these salts are added to the composition of the present invention, they are typically present at a level of from about 0.1% to about 5%, preferably from about 0.2% to about 3%, more preferably from about 0.3% to about 2%, by weight of the composition. When these salts are added to the composition of the present invention it is preferably that incompatible metal salts not be present in the invention. Preferably, when these salts are used the composition should be essentially free of zinc and other incompatible metal ions, e.g., Ca, Fe, Ba, etc. which form water-insoluble salts.

### Enzymes

Enzymes can be used to control certain types of malodor, especially malodor from urine and other types of excretions, including regurgitated materials. Proteases are especially desirable. The activity of commercial enzymes depends very much on the type and purity of the enzyme being considered. Enzymes that are water soluble proteases like pepsin, tripsin, ficin, bromelin, papain, rennin, and mixtures thereof are particularly useful.

Enzymes are normally incorporated at levels sufficient to provide up to about 5 mg by weight, preferably from about 0.001 mg to about 3 mg, more preferably from about 0.002 mg to about 1 mg, of active enzyme per gram of the aqueous compositions. Stated otherwise, the aqueous compositions herein can comprise from about 0.0001% to about 0.5%, preferably from about 0.001% to about 0.3%, more preferably from about 0.005% to about 0.2% by weight of a commercial enzyme preparation. Protease enzymes are usually present in such commercial preparations at levels sufficient to provide from 0.0005 to 0.1 Anson units (AU) of activity per gram of aqueous composition,

Nonlimiting examples of suitable, commercially available, water soluble proteases are pepsin, tripsin, ficin, bromelin, papain, rennin, and mixtures thereof Papain can be isolated, e.g., from papaya latex, and is available commercially in the purified form of up to, e.g., about 80% protein, or cruder, technical grade of much lower activity. Other suitable examples of proteases are the subtilisins which are obtained from particular strains of B. subtilis and B. licheniforms. Another suitable protease is obtained from a strain of Bacillus, flaying maximum activity throughout the pH range of 8-12, developed and sold by Novo Industries A/S under the registered trade name ESPERASE®. The preparation of this enzyme and analogous enzymes is described in British Patent Specification No. I ,243,784 of Novo. Proteolytic enzymes suitable for removing protein-based stains that are commercially available include those sold under the trade names ALCALASE® and SAVINASE® by Novo Industries A/S (Denmark) and MAXATASE® by International Bio-Synthetics, Inc. (The Netherlands). Other proteases include Protease A (see European Patent Application 130,756, published Jan. 9, 1985); Protease B (see European Patent Application Serial No. 87303761.8, filed Apr. 28, 1987, and European Patent Application 130,756, Bott et al, published Jan. 9, 1985); and proteases made by Genencor International, Inc., according to one or more of the following patents: Caldwell et al, U.S. Pat. Nos. 5,185,258, 5,204,015 and 5,244,791.

A wide range of enzyme materials and means for their incorporation into liquid compositions are also disclosed in U.S. Pat. No. 3,553,139, issued Jan. 5, 1971 to McCarty et al. Enzymes are further disclosed in U.S. Pat. No. 4,101,457, Place et al, issued Jul. 18, 1978, and in U.S. Pat. No. 4,507,219, Hughes, issued Mar. 26, 1985. Other enzyme materials useful for liquid formulations, and their incorporation into such formulations, are disclosed in U.S. Pat. No. 4,261,868, Hora et al, issued Apr. 14, 1981. Enzymes can be stabilized by various techniques, e.g., those disclosed and exemplified in U.S. Pat. No. 3,600,319, issued Aug. 17, 1971 to Gedge, et al., European Patent Application Publication No. 0 199 405, Application No. 86200586.5, published Oct. 29, 1986, Venegas, and in U.S. Pat. No. 3,519,570.

Enzyme-polyethylene glycol conjugates are also preferred. Such polyethylene glycol (PEG) derivatives of enzymes, wherein the PEG or alkoxy-PEG moieties are coupled to the protein molecule through, e.g., secondary amine linkages. Suitable derivatization decreases immunogenicity, thus minimizes allergic reactions, while still maintaining some enzymatic activity. An example of protease-PEG's is PEG-subtilisin Carlsberg from B. lichenniformis coupled to methoxy-PEGs through secondary amine linkage, and is available from Sigma-Aldrich Corp., St. Louis, Mo.

### Perfume

The color restoration compositions described herein can also optionally provide a “scent signal” in the form of a pleasant odor which provides a freshness impression to the treated fabrics. The scent signal can be designed to provide a fleeting perfume scent. When perfume is added as a scent signal, it is added only at very low levels, e.g., from about 0.001% to about 5.0%, preferably from about 0.003% to about 3.0%, more preferably from about 0.005% to about 1.0%, by weight of the usage composition. Suitable perfumes, perfume ingredients, and perfume carriers are described in U.S. Pat. No. 5,500,138; and US 20020035053 A1.

Perfume can also be added as a more intense odor in product and on fabrics. When higher levels of fabric freshness are preferred, relatively higher levels of perfume can be added.

Any type of perfume can be incorporated into the composition of the present invention. The preferred perfume ingredients are those suitable for use to apply on fabrics and garments. Typical examples of such preferred ingredients are given in U.S. Pat. No. 5,445,747, issued Aug. 29, 1995 to Kvietok et al.

When long lasting fragrance odor on fabrics is desired, it is preferred to use at least an effective amount of perfume ingredients which have a boiling point of about 240° C. or higher, preferably of about 250° C. or higher. Nonlimiting examples of such preferred ingredients are given in U.S. Pat. No. 5,500,138, issued Mar. 19, 1996 to Bacon et al. It is also preferred to use materials that can slowly release perfume ingredients after the fabric is treated by the wrinkle control composition of this invention. Examples of materials of this type are given in U.S. Pat. No.5,531,910, Severns et al., issued Jul. 2, 1996.

When cyclodextrin is present, it is essential that the perfume be added at a level wherein even if all of the perfume in the composition were to complex with the cyclodextrin molecules when cyclodextrin is present, there will still be an effective level of uncomplexed cyclodextrin molecules present in the solution to provide adequate odor control. Alternatively, cyclodextrin can be incorporated into color restoration compositions as principally an anti-slip agent; in such cases it is not a concern whether or how much perfume is complexed with the cyclodextrin. In order to reserve an effective amount of cyclodextrin molecules for odor control when cyclodextrin is present, perfume is typically present at a level wherein less than about 90% of the cyclodextrin complexes with the perfume, preferably less than about 50% of the cyclodextrin complexes with the perfume, more preferably, less than about 30% of the cyclodextrin complexes with the perfume, and most preferably, less than about 10% of the cyclodextrin complexes with the perfume. The cyclodextrin to perfume weight ratio should be greater than about 8: 1, preferably greater than about 10: 1, more preferably greater than about 20: 1, even more preferably greater than 40:1 and most preferably greater than about 70:1.

Preferably the perfume is hydrophilic and is composed predominantly of ingredients selected from two groups of ingredients, namely, (a) hydrophilic ingredients having a ClogP of less than about 3.5, more preferably less than about 3.0, and (b) ingredients having significant low detection threshold, and mixtures thereof. Typically, at least about 50%, preferably at least about 60%, more preferably at least about 70%, and most preferably at least about 80% by weight of the perfume is composed of perfume ingredients of the above groups (a) and (b). For these preferred perfumes, the cyclodextrin to perfume weight ratio is typically of from about 2:1 to about 200:1; preferably from about 4:1 to about 100:1, more preferably from about 6:1 to about 50:1, and even more preferably from about 8:1 to about 30:1.

In some cases it is preferred to use at least some perfume components wherein the ingredients have a Clog P of greater than about 3.5; for example, when trying to produce a matching scent to a rinse-added liquid fabric softener composition.

### Hydrophilic Perfume Ingredients

The hydrophilic perfume ingredients are more soluble in water, have less of a tendency to complex with the cyclodextrins, and are more available in the odor absorbing composition than the ingredients of conventional perfumes. The degree of hydrophobicity of a perfume ingredient can be correlated with its octanol/water partition coefficient P. The octanol/water partition coefficient of a perfume ingredient is the ratio between its equilibrium concentration in octanol and in water. A perfume ingredient with a greater partition coefficient P is considered to be more hydrophobic. Conversely, a perfume ingredient with a smaller partition coefficient P is considered to be more hydrophilic. Since the partition coefficients of the perfume ingredients normally have high values, they are more conveniently given in the form of their logarithm to the base 10, logP. Thus the preferred perfume hydrophilic perfume ingredients of this invention have logP of about 3.5 or smaller, preferably of about 3.0 or smaller.

The logP of many perfume ingredients have been reported; for example, the Pomona92 database, available from Daylight Chemical Information Systems, Inc. (Daylight CTS), Irvine, California, contains many, along with citations to the original literature. However, the logP values are most conveniently calculated by the “CLOGP” program, also available from Daylight CIS. This program also lists experimental logP values when they are available in the Pomona92 database. The “calculated logP” (ClogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The ClogP values, which are the most reliable and widely used estimates for this physicochemical property, are used instead of the experimental logP values in the selection of perfume ingredients which are useful in the present invention.

Non-limiting examples of the more preferred hydrophilic perfume ingredients are allyl amyl glycolate, allyl caproate, amyl acetate, amyl propionate, anisic aldehyde, anisyl acetate, anisole, benzaldehyde, benzyl acetate, benzyl acetone, benzyl alcohol, benzyl formate, benzyl iso valerate, benzyl propionate, beta gamma hexenol, calone, camphor gum, laevo-carveol, d-carvone, laevo-carvone, cinnamic alcohol, cinnamyl acetate, cinnamic alcohol, cinnamyl formate, cinnarnyl propionate, cis-jasmone, cis-3-hexenyl acetate, coumarin, cuminic alcohol, cuminic aldehyde, Cyclal C, cyclogalbanate, dihydroeuginol, di hydro isoj asmonate, dimethyl benzyl carbinol, dimethyl benzyl carbinyl acetate, ethyl acetate, ethyl aceto acetate, ethyl amyl ketone, ethyl anthranilate, ethyl benzoate, ethyl butyrate, ethyl cinnamate, ethyl hexyl ketone, ethyl maltol, ethyl-2-methyl butyrate, ethyl methylphenyl glycidate, ethyl phenyl acetate, ethyl salicylate, ethyl vanillin, eucalyptol, eugenol, eugenyl acetate, eugenyl formate, eugenyl methyl ether, fenchyl alcohol, for acetate (tricyclo decenyl acetate), fructone, frutene (tricyclo decenyl propionate), geraniol, geranyl oxyacetaldehyde, heliotropin, hexenol, hexenyl acetate, hexyl acetate, hexyl formate, hinokitiol, hydrotropic alcohol, hydroxycitronellal, hydroxycitronellal diethyl acetal, hydroxycitronellol, indole, isoamyl alcohol, iso cyclo citral, isoeugenol, isoeugenyl acetate, isomenthone, isopulegyl acetate, isoquinoline, keone, ligustral, linalool, linalool oxide, linalyl formate, lyral, menthone, methyl acetophenone, methyl amyl ketone, methyl anthranilate, methyl benzoate, methyl benzyl acetate, methyl cinnamate, methyl dihydrojasmonate, methyl eugenol, methyl heptenone, methyl heptine carbonate, methyl heptyl ketone, methyl hexyl ketone, methyl isobutenyl tetrahydropyran, methyl-N-methyl anthrani late, methyl beta naphthyl ketone, methyl phenyl carbinyl acetate, methyl salicylate, nerol, nonalactone, octalactone, octyl alcohol (octanol-2), para-anisic aldehyde, paracresol, para-cresyl methyl ether, para hydroxy phenyl butanone, para-methoxy acetophenone, para-methyl acetophenone, phenoxy ethanol, phenoxyethyl propionate, phenyl acetaldehyde, phenylacetaldehyde diethyl ether, phenylethyl oxyacetaldehyde, phenyl ethyl acetate, phenyl ethyl alcohol, phenyl ethyl dirnethyl carbinol, prenyl acetate, propyl butyrate, pulegone, rose oxide, safrole, terpineol, vanillin, viridine, and mixtures thereof

Nonlimiting examples of other preferred hydrophilic perfume ingredients which can be used in perfume compositions of this invention are ailyl heptoate, amyl benzoate, anethole, benzophenone, canvacrol, citral, citronellol, citronellyl nitrile, cyciohexyl ethyl acetate, cymal, 4-decenal, dihydro isojasmonate, dihydro myrcenol, ethyl methyl phenyl glycidate, fenchyl acetate, florhydral, gamma-nonalactone, geranyl formate, geranyl nitrile, hexenyl isobutyrate, alpha-ionone, isobomyl acetate, isobutyl benzoate, isononyl alcohol, isomenthol, para-isopropyl phenylacetaldehyde, isopulegol, linalyl acetate, 2-methoxy naphthalene, menthyl acetate, methyl chavicol, musk ketone, beta naphthol methyl ether, neral, nonyl aldehyde, phenyl heptanol, phenyl hexanol, terpinyl acetate, Veratrol, yara-yara, and mixtures thereof.

The preferred perfume compositions used in the present invention contain at least 4 different hydrophilic perfume ingredients, preferably at least 5 different hydrophilic perfume ingredients, more preferably at least 6 different hydrophilic perfume ingredients, and even more preferably at least 7 different hydrophilic perfume ingredients. Most common perfume ingredients which are derived from natural sources are composed of a multitude of components. When each such material is used in the formulation of the preferred perfume compositions of the present invention, it is counted as one single ingredient, for the purpose of defining the invention.

### Low Odor Detection Threshold Perfume Ingredients

The odor detection threshold of an odorous material is the lowest vapor concentration of that material which can be olfactorily detected. The odor detection threshold and some odor detection threshold values are discussed in, e.g., “Standardized Human Olfactory Thresholds”, M. Devos et al, IRL Press at Oxford University Press, 1990, and “Compilation of Odor and Taste Threshold Values Data”, F. A. Fazzalari, editor, ASTM Data Series DS 48A, American Society for Testing and Materials, 1978. The use of small amounts of perfume ingredients that have low odor detection threshold values can improve perfume odor character, even though they are not as hydrophilic as perfume ingredients of group (a) which are given hereinabove. Perfume ingredients that do not belong to group (a) above, but have a significantly low detection threshold, useful in the composition of the present invention, are selected from the group consisting of ambrox, bacdanol, benzyl salicylate, butyl anthranilate, cetalox, damascenone, alpha-damascone, gamma-dodecalactone, ebanol, herbavert, cis-3-hexenyl salicylate, alpha-ionone, beta-ionone, alphaisomethylionone, lilial, methyl nonyl ketone, gamma-undecalactone, undecylenic aldehyde, and mixtures thereof. These materials are preferably present at low levels in addition to the hydrophilic ingredients of group (a), typically less than about 20%, preferably less than about 15%, more preferably less than about 10%, by weight of the total perfume compositions of the present invention. However, only low levels are required to provide an effect.

There are also hydrophilic ingredients of group (a) that have a significantly low detection threshold, and are especially useful in the composition of the present invention. Examples of these ingredients are allyl amyl glycolate, anethole, benzyl acetone, calone, cinnamic alcohol, coumanin, cyclogalbanate, Cyclal C, cymal, 4-decenal, dihydro isojasmonate, ethyl anthranilate, ethyi-2-methyl butyrate, ethyl methyiphenyl glycidate, ethyl vanillin, eugenol, flor acetate, florhydral, fructone, frutene, heliotropin, keone, indole, iso cyclo citral, isoeugenol, lyral, methyl heptine carbonate, linalool, methyl anthranilate, methyl dihydroj asmonate, methyl isobutenyl tetrahydropyran, methyl beta naphthyl ketone, beta naphthol methyl ether, nerol, para-anisic aldehyde, para hydroxy phenyl butanone, phenyl acetaldehyde, vanillin, and mixtures thereof. Use of low odor detection threshold perfume ingredients minimizes the level of organic material that is released into the atmosphere.

### Perfume Microcapsules

In one embodiment, the perfume comprises a perfume microcapsule. Suitable perfume microcapsules and perfume nanocapsules include: US 2003215417 A1; US 2003216488 A1; US 2003158344 A1; US 2003165692 A1; US 2004071742 A1; US 2004071746 A1; US 2004072719 A1; US 2004072720 A1; EP 1393706 A1; US 2003203829 A1; US 2003195133 A1; US 2004087477 A1; US 20040106536 A1; U.S. Pat. No. 6,645,479; U.S. Pat. No. 6,200,949; U.S. Pat. No. 4,882,220; U.S. Pat. No. 4,917,920; U.S. Pat. No. 4,514,461; US RE 32713; U.S. Pat. No. 4,234,627. For purposes of the present invention, the term “perfume microcapsules” describes both perfume microcapsules and perfume nanocapsules.

### Antimicrobial Active

Optionally, the wrinkle control composition of the present invention comprises an effective amount, to kill, or reduce the growth of microbes, of antimicrobial active; preferably from about 0.001% to about 2%, more preferably from about 0.002% to about 1%, even more preferably from about 0.003% to about 0.3%, by weight of the usage composition. The effective antimicrobial active can function as disinfectants/sanitizers, and is useful in providing protection against organisms that become attached to the fabrics.

Given below are nonlimiting examples of antimicrobial actives which are useful in the present invention:

Pyrithiones, sodium and especially the zinc complex (ZPT); Octopirox; Parabens, including Methylparaben, Propylparaben, Butylparaben, Ethylparaben, Isopropylparaben, Isobutylparaben, Benzylparaben, Sodium Methylparaben, and Sodium Propylparaben; DMDM Hydantoin (Glydant); Methylchloroisothiazolinone/methylisothiazolinone (Kathon CG); Sodium Sulfite; Sodium Bisulfite; Imidazolidinyl Urea; Diazolidinyl Urea (Germail 2); Sorbic Acid/Potassium Sorbate; Dehydroacetic Acid/Sodium Dehydroacetate; Benzyl Alcohol; Sodium Borate; 2-Bromo-2-nitropropane-I ,3-diol (Bronopol); Formalin; Iodopropynyl Butylcarbamate; Boric Acid; Chloroacetamide; Methenami lie; Methyldibromo Glutaronitrile; Glutaraldehyde; Hexamidine Isethionate; 5-bromo-5-nitro-1,3-dioxane; Phenethyl Alcohol; o-Phenylphenol/sodi urn o-phenylphenol; Sodium Hydroxymethylglycinate; Polymethoxy Bicyclic Oxazolidine; Dimethoxane; Thimersol; Dichlorobenzyl alcohol; Captan; Chlorphenenesin; Dichlorophene; Chiorbutanol; Phenoxyethanol; Phenoxyisopropanol; Halogenated Diphenyl Ethers; 2,4,4′-trichloro-2′-hydroxy-diphenyl ether (Triclosan); 2,2′-dihydroxy-5,5′-dibromo-diphenyl ether; Phenolic Compounds—(including phenol and its homologs, mono- and poly-alkyl and aromatic halophenols, resorcinol and its derivatives, bisphenolic compounds and halogenated salicylanilides); Phenol and its Homologs including Phenol, 2 Methyl Phenol, 3 Methyl Phenol, 4 Methyl Phenol, 4 Ethyl Phenol, 2,4-Dimethyl Phenol, 2,5-Dimethyl Phenol, 3,4-Dimethyl Phenol, 2,6-Dimethyl Phenol, 4-n-Propyl Phenol, 4-n-Butyl Phenol, 4-n-Arnyl Phenol, 4-tert-Amyl Phenol, 4-n-Hexyl Phenol, and 4-n-Heptyl Phenol; Mono- and Poly-Alkyl and Aromatic Halophenols including p-Chlorophenol, Methyl p-Chlorophenol, Ethyl p-Chlorophenol, n-Propyl p-Chlorophenol, n-Butyl p-Chlorophenol, n-Amyl p-Chlorophenol, sec-Amyl p-Chlorophenol, n-Hexyl p-Chlorophenol, Cyclohexyl p-Chlorophenol, n-Heptyl p-Chlorophenol, n-Octyl p-Chlorophenol, o-Chlorophenol, Methyl o-Chlorophenol, Ethyl o-Chlorophenol, n-Propyl o-Chlorophenol, n-Butyl o-Chlorophenol, n-Amyl o-Chlorophenol, tert-Amyl o-Chlorophenol, n-Hexyl o-Chlorophenol, n-Heptyl o-Chlorophenol, o-Benzyl p-Chlorophenol, o-benzyl-m-methyl p-Chlorophenol, o-Benzyl-m, m-dimethyl p-Chlorophenol, o-Phenylethyl p-Chlorophenol, o-Phenylethyl-m-methyl p-Chlorophenol, 3-Methyl p-Chlorophenol, 3,5-Dimethyl p-Chlorophenol, 6-Ethyl-3-methyl p-Chlorophenol, 6-n-Propyl-3-methyl p-Chlorophenol, 6-iso-Propyl-3-methyl p-Chlorophenol, 2-Ethyl-3,5-dimethyl p-Chlorophenol, 6-sec-Butyl-3-methyl p-Chlorophenol, 2-iso-Propyl-3,5-dimethyl p-Chlorophenol, 6-Diethylmethyl-3-methyl p-Chlorophenol, 6-iso-Propyl-2-ethyl-3-methyl p-Chlorophenol, 2-sec-Amyl-3,5-dimethyl p-Chlorophenol, 2-Diethylmethyl-3,5-dimethyl p-Chlorophenol, 6-sec-Octyl-3-methyl p-Chlorophenol, p-Chloro-m-cresol, p-Bromophenol, Methyl p-Bromophenol, Ethyl p-Bromophenol, n-Propyl p-Bromophenol, n-Butyl p-Bromophenol, n-Amyl p-Bromophenol, sec-Amyl p-Bromophenol, n-Hexyl p-Bromophenol, cyclohexyl p-Bromophenoi, o-Bromophenol, tert-Amyl o-Bromophenol, n-Hexyl o-Bromophenol, n-Propyl-m,mDimethyl o-Bromophenol, 2-Phenyl Phenol, 4-Chloro-2-methyl phenol, 4-Chloro-3-methyl phenol, 4-Chloro-3,5-dimethyl phenol, 2,4-dichloro-3,5-dimethylphenol, 3,4,5,6-terabromo-2-methylphenol, 5-methyl-2-pentylphenol, 4-isopropyl-3-methyiphenol, para-chloro-meta-xylenol (PCMX), 5-Chloro-2-hydroxydiphenylmethane; Resorcinol and its Derivatives including Resorcinol, Methyl Resorcinol, Ethyl Resorcinol, n-Propyl Resorcinol, n-Butyl Resorcinol, n-Amyl Resorcinol, n-Hexyl Resorcinol, n-Heptyl Resorcinol, n-Octyl Resorcinol, n-Nonyl Resorcinol, Phenyl Resorcinol, Benzyl Resorcinol, Phenylethyl Resorcinol, Phenylpropyl Resorcinol, p-Chlorobenzyl Resorcinol, 5-Chloro 2,4-Dihydroxydiphenyl Methane, 4′-Chloro 2,4-Dihydroxydiphenyl Methane, 5-Bromo 2,4-Dihydroxydiphenyl Methane, and 4′-Bromo 2,4-Dihydroxydiphenyl Methane; Bisphenolic Compounds including 2,2′-, methylene his (4-chiorophenol), 2,2′-methylene bis (3,4,6-tnichlorophenol), 2,2′-methylene bis (4-chloro-6-bromophenol), bis (2-hydroxy-3.5-dichlorophenyl) sulphide, and bis (2-hydroxy-5-chlorobenzyl)sulphide; Benzoic Esters including p-Hydroxybenzoic Acid, Methyl pHydroxybenzoic Acid, Ethyl p-Hydroxybenzoic Acid, Propyl p-Hydroxybenzoic Acid, and Butyl p-Hydroxybenzoic Acid.

Another class of antibacterial agents, which are useful in the present invention, are the so-called “natural” antibacterial actives, referred to as natural essential oils. These actives derive their names from their natural occurrence in plants. Typical natural essential oil antibacterial actives include oils 01 anise, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, Hydastis carradensis, Berheridaceae daceae, Ratanhiae and Curcuma ion OH. Also included in this class of natural essential oils are the key chemical components of the plant oils which have been found to provide the antimicrobial benefit. These chemicals include, but are not limited to anethol, catechole, camphene, thymol, eugenol, eucalyptol, ferulic acid, farnesol, hinokitiol, tropolone, limonene, menthol, methyl salicylate, salicylic acid, thymol, terpineol, verbenone, berberine, ratanhiae extract, caryophellene oxide, citronellic acid, curcurnin, nerolidol, geraniol and benzoic acid.

Additional active agents are antibacterial metal salts. This class generally includes salts of metals in groups 3b-7b, 8 and 3a-5a. Specifically are the salts of aluminum, zirconium, zinc, silver, gold, copper, lanthanum, tin, mercury, bismuth, selenium, strontium, scandium, yttrium, cerium, praseodymiun, neodymium, promethum, samarium, europium, gadolinium, terbium, dysprosium, holmium, erbium, thulium, ytterbium, lutetium and mixtures thereof

Preferred antimicrobial agents for use herein are the broad spectrum actives selected from the group consisting of Triclosan, phenoxyisopropanol, phenoxyethanol, PCMX, natural essential oils and their key ingredients, and mixtures thereof. The most preferred antimicrobial active for use in the present invention is Triclosan.

### Quaternary Compounds

A wide range of quaternary compounds can also be used as antimicrobial actives, in conjunction with the preferred surfactants, for compositions of the present invention. Non-limiting examples of useful quaternary compounds include: (1) benzalkoniurn chlorides and/or substituted benzalkonium chlorides such as commercially available Barquat® (available from Lonza), Maquat® (available from Mason), Variquat® (available from Witco/Sherex), and Hyamine® (available from Lonza); (2) di(C6-C14)alkyl di-short chain (C1-4 alkyl and/or hydroxyalkyl) quaternary such as Bardac® products of Lonza. These quaternary compounds contain two relatively short chains, e.g., C1-4 alkyl and/or hydroxy alkyl groups and two C6-12, preferably C6-10, and more preferably C8, alkyl groups,(3) N-(3-chloroallyl) hexaminium chlorides such as Dowicide® and Dowicil® available from Dow; (4) benzethonium chloride such as Hyamine® 1622 from Rohm & Haas; (5) methylbenzethonium chloride represented by Hyamine® 10X supplied by Rohm & Haas, (6) cetylpyridinium chloride such as Cepacol chloride available from of Merrell Labs. Examples of the preferred dialkyl quaternary compounds are di(C8-C12)dialkyl dimethyl ammonium chloride, such as didecyldimethylammonium chloride (Bardac 22), dioctyldimethylammonium chloride (Bardac 2050); and hydrogenated tallow 2-ethylhexyl ammonium methosulfate (Arquad HTL8-MS, ex. Akzo). Typical concentrations for biocidal effectiveness of these quaternary compounds range from about 0.001% to about 0.8%, preferably from about 0.005% to about 0.3%, more preferably from about 0.01% to 0.2%, by weight of the usage composition. The corresponding concentrations for the concentrated compositions are from about 0.003% to about 2%, preferably from about 0.006% to about 1.2%, and more preferably from about 0.1% to about 0.8% by weight of the concentrated compositions.

When cyclodextrin is present, the solubilized, water-soluble antimicrobial active is useful in providing protection against organisms that become attached to the treated fabrics. The antimicrobial should be cyclodextrin-compatible, e.g., not substantially forming complexes with the cyclodextrin in the odor absorbing composition when cyclodextrin is present. The free, uncomplexed antimicrobial, e.g., antibacterial, active provides an optimum antibacterial performance.

Sanitization of fabrics can be achieved by the compositions of the present invention containing, antimicrobial materials, e.g., antibacterial halogenated compounds, quaternary compounds, and phenolic compounds, and mixtures thereof.

### Biguanides

Some of the more robust cyclodextrin-compatible antimicrobial halogenated compounds which can function as disinfectants/sanitizers as well as finish product preservatives, and are useful in the compositions of the present invention include 1,1′-hexamethylene bis(5-(p-chlorophenyl)biguanide), commonly known as chlorhexidine, and its salts, e.g., with hydrochloric, acetic and gluconic acids. The digluconate salt is highly water-soluble, about 70% in water, and the diacetate salt has a solubility of about 1.8% in water. When chlorhexidine is used as a sanitizer in the present invention it is typically present at a level of from about 0.001% to about 0.4%, preferably from about 0.002% to about 0.3%, and more preferably from about 0.05% to about 0.2%, by weight of the usage composition. In some cases, a level of from about 1% to about 2% may be needed for virucidal activity.

Other useful biguanide compounds include Cosmoci® CQ®, Vantocil® IB, including poly (hexamethylene biguanide) hydrochloride. Other useful cationic antimicrobial agents include the bis-biguanide alkanes. Usable water soluble salts of the above are chlorides, bromides, sulfates, alkyl sulfonates such as methyl sulfonate and ethyl sulfonate, phenylsulfonates such as p-methylplienyl sulfonates, nitrates, acetates, gluconates, and the like.

Examples of suitable bis biguanide compounds are chlorhexidine; 1,6-bis-(2-ethylhexylbiguanidohexane)dihydrochloride; 1,6-di-(N1,N1′-phenyldiguanido-N5,N5′)-hexane tetrahydrochloride; 1,6-di-(N1,N1′-phenyl-N1,N1′-methyldiguanido-N5,N5′)-hexane dihydrochloride; 1,6-di(N1,N1′-o-chlorophenyldiguanido-N5,N5′)-hexane dihydrochloride; 1,6-di(N1,N1′-2,6-dichlorophenyldiguanido-N5,N5′)hexane dihydrochloride; 1,6-di(N1,N1′-.beta.-(p-methoxyphenyl) diguanido-N5,N5′]-hexane dihydrochloride; 1,6-di(N1,N1′-.alpha.-methyl-.beta.-phenyldiguanido-N5,N5′)-hexane dihydrochloride; 1,6-di(N1,N1′-p-nitrophenyldiguanido-N5,N5′)hexane dihydrochloride;.omega, omega.′-di-(N1,N1′-phenyldiguanido-N5,N5′)-di-n-propylether dihydrochloride;.omega, omega′-di(N1,N1′-p-chlorophenyldiguanido-N5,N5′)-di-n-propylether tetrahydrochloride; 1,6-di(N1,N1′-2,4-dichlorophenyldiguanido-N5,N5′)hexane tetrahydrochloride; 1,6-di(N1,N1′-p-methylphenyldiguanido-N5,N5′)hexane dihydrochloride; 1,6-di(N1,N1′-2,4,5-trichlorophenyldiguanido-N5,N5′)hexane tetrahydrochloride; 1,6-di(N1,N1′-.alpha.(p-chlorophenyl) ethyldiguanido-N5,N5′] hexane dihydrochloride;.omega, omega.′di(N1,N1′-p-chlorophenyldiguanido-N5,N5′)m-xylene dihydrochloride; 1,12-di(N1,N1′-p-chlorophenyldiguanido-N5,N5′) dodecane dihydrochloride; 1,10-di(N1,N1′-phenyldiguanido-N5,N5′)-decane tetrahydrochloride; 1,1 2-di(N1,N1′-phenyldiguanido-N5,N5′) dodecane tetrahydrochloride; 1,6-di(N1,N1′-o-chlorophenyldiguanido-N5,N5′) hexane dihydrochloride; 1,6-di(N1,N1′-p-chlorophenyldiguanido-N5,N5 ′)-hexane tetrahydrochloride; ethylene bis (1-tolyl biguanide); ethylene bis (p-tolyl biguanide); ethylene bis(3,5-dimethylphenyl biguanide); ethylene bis(p-tert-amylphenyl biguanide); ethylene bis(nonylphenyl biguanide); ethylene bis (phenyl biguanide); ethylene bis (N-butylphenyl biguanide); ethylene bis (2,5-diethoxyphenyl biguanide); ethylene bis(2,4-dimethylphenyl biguanide); ethylene bis(o-diphenylbiguanide); ethylene bis(mixed amyl naphthyl biguanide); N-butyl ethylene bis(phenylbiguanide); trimethylene bis(o-tolyl biguanide); N-butyl trimethylene bis(phenyl biguanide); and the corresponding pharmaceutically acceptable salts of all of the above such as the acetates; gluconates; hydrochlorides; hydrobromides; citrates; bisulfites; fluorides; polymaleates; N-coconutalkylsarcosinates; phosphites; hypophosphites; perfluorooctanoates; silicates; sorbates; salicylates; maleates; tartrates; fumarates; ethylenediaminetetraacetates; iminodiacetates; cinnamates; thiocyanates; arginates; pyromellitates; tetracarboxybutyrates; benzoates; glutarates; monofluorophosphates; and perfluoropropionates, and mixtures thereof. Preferred antimicrobials from this group are 1,6-di-(N1,N1′-phenyldiguanido-N5,N5′)-hexane tetrahydrochloride; 1,6-di(N1,N1′-o-chlorophenyidiguanido-N5,N5′)-hexane dihydrochloride; 1,6-di(N1,N1′-2,6-dichlorophenyldiguanido-N5,N5′)hexane dihydrochloride; 1,6-di(N1,N1′-2,4-dichlorophenyldiguanido-N5,N5′)hexane tetrahydrochlonide; 1,6-di[N1,N1′-alpha.-(p-chlorophenyl) ethyldiguanido-N5,N5′] hexane dihydrochloride;.omega, omega.′di(N1,N1′-p-chlorophenyldiguanido-N5,N5′)m-xylene dihydrochloride; 1,12-di(N1,N1′-p-chlorophenyldiguanido-N5,N5′) dodecane dihydrochloride; 1,6-di(N1 ,N1′-o-chlorophenyldiguanido-N5,N5′) hexane dihydrochloride; 1,6-di(N1,N1′-p-chlorophenyldiguanido-N5,N5′)-hexane tetrahydrochloride; and mixtures thereof, more preferably, 1,6-di(N1,N1′-o-chlorophenyldiguanido-N5,N5′)-hexane dihydrochloride; 1,6-di(N1,N1′-2,6-dichlorophenyldiguanido-N5,N5′)hexane dihydrochloride; 1,6-di(N1,N1′-2,4-dichlorophenyldiguanido-N5,N5′)hexane tetrahydrochloride; 1,6-di [N1,N1′-alpha-(p-chlorophenyl) ethyldiguanido-N5,N5′] hexane dihydrochloride;.omega, omega.′di(N1,N1′-p-chlorophenyldiguanido-N5,N5′)m-xylene dihydrochloride; 1,12-di(N1,N1′-p-chlorophenyldiguanido-N5,N5′) dodecane dihydrochloride; 1,6-di(N1,N1′-o-chlorophenyldiguanido-N5,N5′) hexane dihydrochloride; 1,6-di(N1,N1′-p-chlorophenyldiguanido-N5,N5′)-hexane tetrahydrochloride; and mixtures thereof. As stated hereinbefore, the bis biguanide of choice is chlorhexidine its salts, e.g., digluconate, dihydrochloride, diacetate, and mixtures thereof The surfactants, when added to the antimicrobials tend to provide improved antimicrobial action. This is especially true for the siloxane surfactants, and especially when the siloxane surfactants are combined with the chlorhexidine antimicrobial actives.

### Optional Aminocarboxylate Chelators

Chelators, e.g., ethylenediaminetetraacetic acid (EDTA), hydroxyethylene-diaminetriacetic acid, diethylenetriaminepentaacetic acid, and other aminocarboxylate chelators, and mixtures thereof, and their salts, and mixtures thereof, can optionally be used to increase antimicrobial and preservative effectiveness against Gram-negative bacteria, especially Pseudomonas species. Although sensitivity to EDTA and other aminocarhoxylate chelators is mainly a characteristic of Pseudomonas species, other bacterial species highly susceptible to chelators include Achromobacter, Alcaligenes, Azotobacter, Escherichia, Salmonella, Spirillum, and Vibrio. Other groups of organisms also show increased sensitivities to these chelators, including fungi and yeasts. Furthermore, aminocarboxylate chelators can help, e.g., maintaining product clarity, protecting fragrance and perfume components, and preventing rancidity and off odors.

Although these aminocarboxylate chelators may not be potent biocides in their own right, they function as potentiators for improving the performance of other antimicrobials/preservatives in the compositions of the present invention. Aminocarboxylate chelators can potentiate the performance of many of the cationic, anionic, and nonionic antimicrobials/preservatives, phenolic compounds, and isothiazolinones, that are used as antimicrobials/preservatives in the composition of the present invention. Nonlimiting examples of cationic antimicrobials/preservatives potentiated by aminocarboxylate chelators in solutions are chlorhexidine salts (including digluconate, diacetate, and dihydrochlohide salts), and Quaternium-15, also known as Dowicil 200, Dowicide Q, Preventol D1, benzalkonium chloride, cetrimonium, myristalkonium chloride, cetylpyridinium chloride, lauryl pyridinium chloride, and the like. Nonlimiting examples of useful anionic antimicrobials/preservatives which are enhanced by aminocarboxylate chelators are sorbic acid and potassium sorbate. Nonlimiting examples of useful nonionic antimicrobials/preservatives which are potentiated by aminocarboxylate chelators are DMDM hydantoin, phenethyl alcohol, monolaurin, imidazolidinyl urea, and Bronopol (2-bromo-2-nitropropane-1,3-diol).

Examples of useful phenolic antimicrobials/preservatives potentiated by these chelators are chloroxylenol, phenol, tert-butyl hydroxyanisole, salicylic acid, resorcinol, and sodium o-phenyl phenate. Nonlimiting examples of isothiazolinone antimicrobials/preservatives which are enhanced by aminocarboxylate chelators are Kathon, Proxel and Promexal.

The optional chelators are present in the compositions of this invention at levels of, typically, from about 0.01% to about 0.3%, more preferably from about 0.02% to about 0.1%, most preferably from about 0.02% to about 0.05% by weight of the usage compositions to provide antimicrobial efficacy in this invention.

Free, uncomplexed aminocarboxylate chelators are required to potentiate the efficacy of the antimicrobials. Thus, when excess alkaline earth (especially calcium and magnesium) and transitional metals (iron, manganese, copper, and others) are present, free chelators are not available and antimicrobial potentiation is not observed. In the case where significant water hardness or transitional metals are available or where product esthetics require a specified chelator level, higher levels may be required to allow for the availability of free, uncomplexed aminocarboxylate chelators to function as antimicrobial/preservative potentiators.

### Cyclodextrin Preservative

Optionally, but desirably, if cyclodextrin is present, preferably solubilized, water-soluble, antimicrobial preservative can be added to the composition of the present invention if the antimicrobial material is not sufficient to protect the cyclodextrin, or is not present, because cyclodextrin molecules are made up of varying numbers of glucose units which can make them a prime breeding ground for certain microorganisms, especially when in aqueous compositions. This drawback can lead to the problem of storage stability of cyclodextrin solutions for any significant length of time. Contamination by certain microorganisms with subsequent microbial growth can result in an unsightly and/or malodorous solution. Because microbial growth in cyclodextrin solutions is highly objectionable when it occurs, it is highly preferable to include a solubilized, water-soluble, antimicrobial preservative, which is effective for inhibiting and/or regulating microbial growth in order to increase storage stability of the preferably clear, aqueous odor-absorbing solution containing water-soluble cyclodextrin.

It is preferable to use a broad spectrum preservative, e.g., one that is effective on both bacteria (both gram positive and gram negative) and fungi. A limited spectrum preservative, e.g., one that is only effective on a single group of microorganisms, e.g., fungi, can be used in combination with a broad spectrum preservative or other limited spectrum preservatives with complimentary and/or supplementary activity. A mixture of broad spectrum preservatives can also be used. In some cases where a specific group of microbial contaminants is problematic (such as Gram negatives), aminocarboxylate chelators may be used alone or as potentiators in conjunction with other preservatives. These chelators which include, e.g., ethylenediaminetetraacetic acid (EDTA), hydroxyethylenediaminetriacetic acid, diethylenetriarninepentaacetic acid, and other aminocarboxylate chelators, and mixtures thereof, and their salts, and mixtures thereof, can increase preservative effectiveness against Gram-negative bacteria, especially Pseudomonas species.

Antimicrobial preservatives useful in the present invention include biocidal compounds, i.e., substances that kill microorganisms, or biostatic compounds, i.e., substances that inhibit and/or regulate the growth of microorganisms. Suitable preservatives are disclosed in U.S. Pat. Nos. 5,534,165; 5,578,563; 5,663,134; 5,668,097; 5,670,475; and 5,714,137, Trinh et al. issued Jul. 9, 1996; Nov. 26, 1996; Sep. 2, 1997; Sep. 16, 1997; Sep. 23, 1997; and Feb. 3, 1998 respectively. Preferred antimicrobial preservatives are those that are water-soluble and are effective at low levels because the organic preservatives can form inclusion complexes with the cyclodextrin molecules and compete with the malodorous molecules for the cyclodextrin cavities, thus rendering the cyclodextrins ineffective as odor controlling actives. Water-soluble preservatives useful in the present invention are those that have a solubility in water of at least about 0.3 g per 100 ml of water, i.e., greater than about 0.3% at room temperature, preferably greater than about 0.5% at room temperature. These types of preservatives have a lower affinity to the cyclodextrin cavity, at least in the aqueous phase, and are therefore more available to provide antimicrobial activity. Preservatives with a water-solubility of less than about 0.3% and a molecular structure that readily fits into the cyclodextrin cavity, have a greater tendency to form inclusion complexes with the cyclodextrin molecules, thus rendering the preservative less effective to control microbes in the cyclodextrin solution.

The water-soluble antimicrobial preservative in the present invention is included at an effective amount. The term “effective amount” as herein defined means a level sufficient to prevent spoilage, or prevent growth of inadvertently added microorganisms, for a specific period of time. In other words, the preservative is not being used to kill microorganisms on the surface onto which the composition is deposited in order to eliminate odors produced by microorganisms. Instead, it is preferably being used to prevent spoilage of the cyclodextrin solution in order to increase the shelf-life of the composition. Preferred levels of preservative are from about 0.0001% to about 0.5%, more preferably from about 0.0002% to about 0.2%, most preferably from about 0.0003% to about 0.1%, by weight of the usage composition.

In order to reserve most of the cyclodextrins for odor control, the cyclodextrin to preservative molar ratio should be greater than about 5:1, preferably greater than about 10:1, more preferably greater than about 50:1, even more preferably greater than about 100:1.

The preservative can be any organic preservative material which will not cause damage to fabric appearance, e.g., discoloration, coloration, bleaching. Preferred water-soluble preservatives include organic sulfur compounds, halogenated compounds, cyclic organic nitrogen compounds, low molecular weight aldehydes, quaternary ammonium compounds, dehydroacetic acid, phenyl and phenolic compounds, and mixtures thereof.

The preservatives of the present invention can be used in mixtures in order to control a broad range of microorganisms.

Bacteriostatic effects can sometimes be obtained for aqueous compositions by adjusting the composition pH to an acid pH, e.g., less than about pH 4, preferably less than about pH 3, or a basic pH, e.g., greater than about 10, preferably greater than about 11. Low pH for microbial control is not a preferred approach in the present invention because the low pH can cause chemical degradation of the cyclodextrins. High pH for microbial control is also not preferred because at a high pH, e.g., greater than about 10, preferably greater than about 11, the cyclodextrins can be ionized and their ability to complex with organic materials is reduced. Therefore, aqueous compositions of the present invention should have a pH of from about 3 to about 10, preferably from about 4 to about 8, more preferably from about 4.5 to about 6. The pH is typically adjusted with inorganic molecules to minimize complexation with cyclodextrin.

### Other Optional Ingredients

The composition of the present invention can optionally contain adjunct odor-controlling materials, chelating agents, antistatic agents, softeneing agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, malodor control agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers and anti-foaming agents, UV protection agents for fabrics and skin, sun fade inhibitors, anti-allergenic agents, enzymes, water proofing agents, fabric comfort agents, shrinkage resistance agents, stretch resistance agents, stretch recovery agents, functional microcapsules containing active materials such as perfumes, silicones, skin care agents, glycerin, and natural actives such as aloe vera, vitamin E, shea butter and the like, and mixtures thereof in addition to the silicone molecules. The total level of optional ingredients is low, preferably less than about 5%, more preferably less than about 3%, and even more preferably less than about 2%, by weight of the usage composition. These optional ingredients exclude the other ingredients specifically mentioned hereinbefore. Incorporating adjunct odor-controlling materials can enhance the capacity of the cyclodextrin to control odors as well as broaden the range of odor types and molecule sizes which can be controlled. Such materials include, for example, metallic salts, water-soluble cationic and anionic polymers, zeolites, water-soluble bicarbonate salts, and mixtures thereof.

### Water-Soluble Polyionic Polymers

Some water-soluble polyionic polymers, e.g., water-soluble cationic polymer and water-soluble anionic polymers can be used in the composition of the present invention to provide additional odor control benefits.

Cationic polymers, e.g., polyamines

Water-soluble cationic polymers, e.g., those containing amino functionalities, amido functionalities, and mixtures thereof, are useful in the present invention to control certain acid-type odors.

Anionic polymers, e.g., polyacrylic acid

Water-soluble anionic polymers, e.g., polyacrylic acids and their water-soluble salts are useful in the present invention to control certain amine-type odors. Preferred polyacrylic acids and their alkali metal salts have an average molecular weight of less than about 20,000, more preferably less than 15,000, preferably less than 10,000, more preferably from about 500 to about 5,000. Polymers containing sulfonic acid groups, phosphoric acid groups, phosphonic acid groups, and their water-soluble salts, and mixtures thereof, and mixtures with carboxylic acid and carboxylate groups, are also suitable.

Water-soluble polymers containing both cationic and anionic functionalities are: also suitable. Examples of these polymers are given in U.S. Pat. No. 4,909,986, issued Mar. 20, 1990 to N. Kobayashi and A. Kawazoe. Another example of water-soluble polymers containing both cationic and anionic functionalities is a copolymer of dimethyldiallyl ammonium chloride and acrylic acid, commercially available under the trade name Merquat 280® from Calgon.

When a water-soluble polymer is used it is typically present at a level of from about 0.001% to about 3%, preferably from about 0.005% to about 2%, more preferably from about 0.01% to about 1%, and even more preferably from about 0.05% to about 0.5%, by weight of the usage composition.

### Antistatic Agents

The compositions described herein can optionally contain an effective amount of antistatic agent to provide the treated clothes with in-wear static. Preferred antistatic agents are those that are water soluble in at least an effective amount, such that the composition remains a clear or translucent solution. Examples of these antistatic agents are monoalkyl cationic quaternary ammonium compounds, e.g., mono(C10-C14 alkyl)trimethyl ammonium halide, such as monolauryl trimethyl ammonium chloride and monococo trimethyl ammonium chloride, hydroxycetyl hydroxyethyl dimethyl ammonium chloride, available under the trade name Dehyquart E® from Henkel, and ethyl bis(polyethoxy ethanol) alkylammonium ethylsulfate, available under the trade name Variquat 660 from Witco Corp., hydrogenated tallow 2-ethylhexly ammonium methosulfate, available under the trade name Arquad HTL8-MS from Akzo Nobel, polyethylene glycols, polymeric quaternary ammonium salts, such as polymers conforming to the general formula:

—[N(CH₃)₂—(CH₂)₃—NH—CO—NH—(CH₂)₃—N(CH₃)₂⁺—CH₂CH₂OCH₂CH₂]—ₓ²⁺2x[Cl⁻]

available under the trade name Mirapol A-15® from Rhâne-Poulenc, and

—[N(CH₃)₂—(CH₂)₃—NH—CO—(CH₂)₄—CO—NH—(CH₂)₃—N(CH₃)₂(CH₂CH₂OCH₂CH₂]₋ₓ⁺x[Cl⁻],

available under the trade name Mirapol AD-1® from Rhâne-Poulenc, quaternized polyethyleneimines, vinylpyrrolidone/methacrylamidopropyltrimethylammonium chloride copolymer, available under the trade name Gafquat HS-100® from GAF; triethonium hydrolyzed collagen ethosulfate, available under the trade name QuatPro E® from Maybrook; neutralized sulfonated polystyrene, available, e.g., under the trade name Versa TL-130® from Alco Chemical, neutralized sulfonated styrene/maleic anhydride copolymers, available, e.g., under the trade name Versa TL-4® from Alco Chemical; ethoxylated fatty compounds; ethoxylated surfactants (e.g., polysorbates); and mixtures thereof.

Still other antistatic agents include dialkyl and monoalkyl cationic surfactants and mixtures thereof, and combinations of monoalkyl cationic surfactant and fatty acids. Especially preferred are tallow trimethylammonium chloride, cocotrimethylammounium chloride, oleyltrimethylammounium chloride, and lauryltrimethylammonium chloride. Other examples are ditallowdimethylammonium chloride, ditallowdimethylammonium methyl sulfate, N,N-di(tallowoyloxyethyl)-N,N-dimethylammonium chloride (available from Akzo under the trade name Armosoft® DEQ), N,N-di(canola-oyloxyethyl)-N,N-dimethylammonium chloride (available from Degussa under the trade name Adogen® CDMC), and di-(oleoyloxyethyl)-N,N-methylhydroxyethylammonium methyl sulfate sold under the trade names Rewoquat® WE 15 and Varisoft® WE 16, both available from Degussa. Other antistatic agents include glycerol monostearate (Atmer® 129 from Uniqema), Ethofat® 245/25 (ethoxylated tall oil from Akzo Nobel), DC-5200® (lauryl PEG/PPG 18/18 methicone from Dow Corning), Ethomeen® 18/12 (bis[2-hydroxyethyl]octadecylamine from Akzo Nobel), Ethomeen® HT/12 (hydrogenated tallow amine 2 EO from Akzo Nobel), and Wacker L656 aminofunctional silicone (from Wacker Chemical Corporation).

It is preferred that a no foaming, or low foaming, agent is used, to avoid foam formation during fabric treatment. However, a visible fast-breaking foam appearance can be useful for the consumer to help determine where they have sprayed the product on fabrics. It is also preferred that polyethoxylated agents such as polyethylene glycol or Variquat 66® are not used when alpha-cyclodextrin is used. The polyethoxylate groups have a strong affinity to, and readily complex with, alpha-cyclodextrin which in turn depletes the uncomplexed cyclodextrin available for odor control.

When an antistatic agent is used it is typically present at a level of from about 0.001% to about 10%, preferably from about 0.05% to about 5%, more preferably from about 0.1% to about 3%, by weight of the usage composition.

### Softening Agents

One aspect of the invention provides for the addition of a fabric softening active. In one embodiment, the fabric softening active is cationically charged. In yet still another embodiment, the fabric softening active comprises a quaternary ammonium compound.

Diester Quaternary Ammonium (DEQA) Compounds

In one embodiment, the fabric softening active comprises a DEQA compound. The DEQA compounds encompass a description of diamido fabrics softener actives as well as fabric softener actives with mixed amido and ester linkages.

A first type of DEQA suitable as a fabric softening active in the present compositions includes compounds of the formula:

{R₄₋ₘ—N⁺—[(CH₂)ₙ—Y—R¹]ₘ}X—

wherein each R substituent is either hydrogen, a short chain C₁-C₆, preferably C₁-C₃ alkyl or hydroxyalkyl group, e.g., methyl (most preferred), ethyl, propyl, hydroxyethyl, and the like, poly (C₂-₃ alkoxy), preferably polyethoxy, group, benzyl, or mixtures thereof; each m is 2 or 3; each n is from 1 to about 4, preferably 2; each Y is —O—(O)C—, —C(O)—O—, —NR—C(O)—, or —C(O)—NR— and it is acceptable for each Y to be the same or different; the sum of carbons in each R¹, plus one when Y is —O—(O)C— or —NR—C(O)—, is C₁₂-C₂₂, preferably C₁₄-C₂₀, with each R¹ being a hydrocarbyl, or substituted hydrocarbyl group; it is acceptable for R¹ to be unsaturated or saturated and branched or linear and preferably it is linear; it is acceptable for each R¹ to be the same or different and preferably these are the same; and X— can be any softener-compatible anion, preferably, chloride, bromide, methylsulfate, ethylsulfate, sulfate, phosphate, and nitrate, more preferably chloride or methyl sulfate.
Other suitable fabric softening actives are described in U.S. Pat. Pub. 2004/0204337 A1, published Oct. 14, 2004, at paragraphs 74-79 and U.S. Pat. Pub. 2006/0079438 A1, published April 13, 2006, at paragraphs 0068-0088.

In another embodiment, the fabric softening active is chosen from at least one of the following: ditallowoyloxyethyl dimethyl ammonium chloride, dihydrogenated-tallowoyloxyethyl dimethyl ammonium chloride, dicanola-oyloxyethyl dimethyl ammonium chloride, ditallow dimethyl ammonium chloride, tritallow methyl ammonium chloride, methyl bis(tallow amidoethyl)2-hydroxyethyl ammonium methyl sulfate, methyl bis(hydrogenated tallow amidoethyl)-2-hydroxyethyl ammonim methyl sulfate, methyl bis (oleyl amidoethyl)-2-hydroxyethyl ammonium methyl sulfate, ditallowoyloxyethyl dimethyl ammonium methyl sulfate, dihydrogenated-tallowoyloxyethyl dimethyl ammonium chloride, dicanola-oyloxyethyl dimethyl ammonium chloride, N-tallowoyloxyethyl-N-tallowoylaminopropyl methyl amine, 1,2-bis(hardened tallowoyloxy)-3-trimethylammonium propane chloride, and mixtures thereof.

Other Softening Actives

Non-limiting examples of these other agents include: clays, fatty oils, such as fatty acids, triglycerides, fatty alcohols, fatty esters, fatty amides, fatty amines; sucrose esters, dispersible polyethylenes, hydrocarbon oils, and polymer latexes. These compounds are known in the art and are further described in U.S. Provisional Pat. Appl. No. 60/653,897 filed Mar. 11, 2005 (P&G Case 9910P) and subsequent U.S. provisional and non-provisional patent applications thereof. Examples of fatty acids are described in U.S. Provisional Pat. Appl. No. 60/621,204, filed Nov. 22, 2004 (P&G Case 9812P) and subsequent U.S. provisional and non-provisional patent application thereof. Clays are described in U.S. Pat. Pub. No. 2004/0142841 A1, published Jul. 22, 2004, to de Buzzaccarini et al., from paragraphs 74-99.

The nonionic fabric softeners can typically comprise sucrose esters. Sucrose ester is composed of a sucrose moiety having one or more of its hydroxyl groups esterified.

Sucrose is a disaccharide having the following formula:

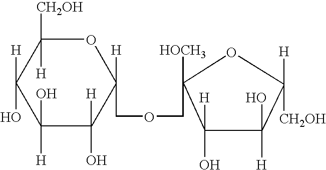

Alternatively, the sucrose molecule can be represented by the formula: M(OH)₈, wherein M is the disaccharide backbone and there are total of 8 hydroxyl groups in the molecule.

Thus, sucrose esters can be represented by the following formula:

M(OH)₈₋ₓ(OC(O)R¹)ₓ

wherein x is the hydroxyl groups that are esterified and (8-x) is the hydroxyl groups that remain unchanged; x is an integer selected from 1 to 8, or from 2 to 8, or from 3 to 8, or from 4 to 8; and R¹ moieties are independently selected from C1-C22 alkyl or C1-C30 alkoxy, linear or branched, cyclic or acyclic, saturated or unsaturated, substituted or unsubstituted.

In one embodiment, the R¹ moieties comprise linear alkyl or alkoxy moieties having independently selected and varying chain length. For example, R¹ may comprise a mixture of linear alkyl or alkoxy moieties wherein greater than about 20% of the linear chains are C18, or greater than about 50% of the linear chains are C18, or greater than about 80% of the linear chains are C 18.

In another embodiment, the R¹ moieties comprise a mixture of saturate and unsaturated alkyl or alkoxy moieties; the degree of unsaturation can be measured by “Iodine Value” (hereinafter referred as “IV”, as measured by the standard AOCS method). The IV of the sucrose esters suitable for use herein ranges from about 1 to about 150, or from about 2 to about 100, or from about 5 to about 85. The R¹ moieties may be hydrogenated to reduce the degree of unsaturation.

In a further embodiment, the unsaturated R¹ moieties may comprise a mixture of “cis” and “trans” forms about the unsaturated sites. The “cis”/“trans” ratios may range from about 1:1 to about 50:1, or from about 2:1 to about 40:1, or from about 3:1 to about 30:1, or from about 4:1 to about 20:1.

### Particulate-Controlling Polymers

Preventing particulates such as dust and/or allergens, from becoming airborne from a surface such as a fabric or garment can be highly desirable, and comprises the step of contacting the surface with an aqueous composition of this invention comprising a particulate-controlling polymer, aqueous carrier, and optional ingredients preferably selected from plasticizers, solvents, odor control agents, aerosol propellants, surfactants, microcapsules containing an active material, perfume, preservatives/antimicrobial actives, wrinkle control agents and the like. Highly preferred optional ingredients to combine with the particulate-controlling polymer in the aqueous compositions of the present methods include plasticizers, odor control agents, and/or surfactants (especially surfactants having a molecular weight of at least about 1,000). The compositions when applied to a fabric or surface according to the present methods, tend to form a film on the surface that can prevent the particulates from becoming airborne. The silicone polymers of this invention can also performance a similar function but with the added benefits (such as coloration restoration and a soft, smooth feel) as heretofore described.

The compositions used in the present methods and articles can optionally comprise one or more particulate-controlling polymers. These particulate-controlling polymers tend to form film on the surface being treated, after the composition is applied to the surface and evaporates.

The particulate-controlling polymers suitable herein can exhibit a wide range of glass transition temperatures (“T_{g}”), which is the temperature at which a polymer changes from a brittle vitreous state to a plastic state. The particulate-controlling polymers can have a T_{g} of from about −50° C. to about 500° C, preferably from about −30° C. to about 400° C., and more preferably from about −20° C. to about 300° C. Preferred polymers herein have a T_{g} of at least about 20° C., preferably at least about 25° C., and more preferably at least about 30° C. Polymers having higher T_{g} values can be used, but preferably in combination with a plasticizer.

Particulate-controlling polymers suitable for use in the compositions of the present methods are preferably selected from the group consisting of alginates, alkyl and hydroxyalkylcellulose, carboxymethylcellulose, carrageenan, guar gum, gum agar, gum arabic, gum ghatti, gum karaya, gum tragacanth, hydroxyethylcellulose, hydroxypropylcellulose, locust bean gum, pectins, polyacrylamide, polyacrylic acid, homologs of polyacrylic acid, polysiloxane, homologs of polysiloxane, polyethylene glycol, polyethylene oxide, polyvinyl alcohol, polyvinylpyrrolidone, starch, starch derivatives, tamarind gum, xanthum gum, other polymers, and mixtures thereof.

The compositions of the present methods will generally comprise a particulate-controlling polymer at a level of from about 0.01% to about 20%, preferably from about 0.05% to about 10%, and more preferably from about 0.1% to about 5%, by weight of the composition. In preferred compositions, such as spray compositions, the level of particulate-controlling polymer is preferably less than about 1%, more preferably less than about 0.9%, and even more preferably less than about 0.8%, by weight of the composition.

Non-limiting examples of suitable alginates include ammonium alginate.

Non-limiting examples of suitable alkyl and hydroxyalkylcellulose polymers include ethylcellulose, cellulose acetate, cellulose acetate butyrate, cellulose acetate propionate, cellulose acetate propionate carboxylate, hydroxybutyl methylcellulose, hydroxyethylcellulose Hydroxyethyl Chitosan, Hydroxyethyl Ethylcellulose, Hydroxyethyl/Methoxyethyl Acrylates Copolymer, Hydroxypropylcellulose, Hydroxypropyl Chitosan, Hydroxypropyl Guar, Hydroxypropyl Methylcellulose, Hydroxypropyl Methylcellulose Acetate/Succinate, Methyl Ethylcellulose, and mixtures thereof.

Non-limiting examples of suitable carboxymethylcellulose polymers include Carboxymethyl Dextran, Carboxymethyl Hydroxyethylcellulose, Calcium Carboxymethyl Cellulose, and mixtures thereof.

Non-limiting examples of suitable carrageenan polymers include Calcium Carrageenan, Sodium Carrageenan, Potassium Carrageenan, and mixtures thereof.

Non-limiting examples of suitable acrylamides include Aminoethylpropanediol-Acrylates/Acrylamide Copolymer, Aminoethylpropanediol-AMPD-Acrylates/Diacetoneacrylamide Copolymer, Polyacrylamide, Polyacrylamidomethylpropane Sulfonic Acid, and mixtures thereof.

Non-limiting examples of suitable polyacrylic acid polymers and homologs of polyacrylic acid include Acrylamide/Ammonium Acrylate Copolymer, Acrylamides Copolymer, Acrylamides/DMAPA, Acrylates/Methoxy PEG Methacrylate Copolymer, Acrylamide/Sodium Acrylate Copolymer, Acrylamidopropyltrimonium Chloride/Acrylamide Copolymer, Acrylamidopropyltrimonium, Chloride/Acrylates Copolymer, Acrylates/Acetoacetoxyethyl Methacrylate Copolymer, Acrylates/Acrylamide Copolymer, Acrylates/Ammonium Methacrylate Copolymer, Acrylates Copolymer, Acrylates/Diacetoneacrylamide Copolymer, Acrylates/Dimethicone Copolymer, Acrylates/Dimethylaminoethyl Methacrylate Copolymer, Acrylates/Ethylhexyl Acrylate Copolymer, Acrylates/Hydroxyesters Acrylates Copolymer, Acrylates/Octylacrylamide Copolymer, Acrylates/PVP Copolymer, Acrylates/Stearyl Acrylate/Dimethicone Acrylate Copolymer, Acrylates/VA Copolymer, Acrylates/VA Crosspolymer, Acrylic Acid/Acrylonitrogens Copolymer, Aminoethylacrylate Phosphate/Acrylates Copolymer, Ammonium Acrylates Copolymer, Ammonium Acrylates/Acrylonitrogens Copolymer, Ammonium Polyacrylate, Ammonium Styrene/Acrylates Copolymer, Ammonium VA/Acrylates Copolymer, AMP-Acrylates/C1-18 Alkyl Acrylates/C1-8 Alkyl Acrylamide Copolymer, AMP-Acrylates Copolymer, AMP-Acrylates/Diacetoneacrylamide Copolymer, AMP-Acrylates/Dimethylaminoethylmethacrylate Copolymer, AMPD-Acrylates/Diacetoneacrylamide Copolymer, Butyl Acrylate/Ethylhexyl Methacrylate Copolymer, Butyl Acrylate/Hydroxyethyl Methacrylate Copolymer, Butyl Acrylate/Styrene Copolymer, Calcium/Sodium PVM/MA Copolymer, DEA-Styrene/Acrylates/DVB Copolymer, DMAPA Acrylates/Acrylic Acid/Acrylonitrogens Copolymer, Dimethicone Copolyol Polyacrylate, Lauryl Methacrylate/Glycol Dimethacrylate Copolymer, Methacryloyl Ethyl Betaine/Acrylates Copolymer, Methyl Methacrylate/Acrylonitrile Copolymer, Methyl Methacrylate Crosspolymer, Octadecene/MA Copolymer, Octylacryamide/Acrylates/Butylaminoethyl Methacrylate Copolymer, Polyacrylate, Polyacrylic Acid, Polyethylmethacrylate, Polymethyl Acrylate, Polybutyl Acrylate, Polyethylacrylate, Polydimethylaminoethyl Methacrylate, Polymethyl Methacrylate, Sodium Acrylate/Vinyl Alcohol Copolymer, Sodium Acrylates Copolymer, Sodium Acrylates/Acrolein Copolymer, Sodium Acrylates/Acrylonitrogens Copolymer, Sodium DVB/Acrylates Copolymer, Sodium Polyacrylate, Sodium Polymethacrylate, Sodium Styrene/Acrylates Copolymer, Sodium Tauride Acrylates/Acrylic Acid/Acrylonitrogens Copolymer, Starch/Acrylates/Acrylamide Copolymer, Steareth-10 Allyl Ether/Acrylates Copolymer, Styrene/Acrylates/Acrylonitrile Copolymer, Styrene/Acrylates/Ammonium Methacrylate Copolymer, Styrene/Acrylates Copolymer, Sodium PVM/MA/Decadiene Crosspolymer, Stearylvinyl Ether/MA Copolymer, Styrene/MA Copolymer, Styrene/Methacrylamide/Acrylates Copolymer, Tromethamine Acrylates/Acrylonitrogens Copolymer, Vinyl Caprolactam/PVP/Dimethylaminoethyl Methacrylate Copolymer, Ethyl Acrylate/Methacrylic Acid Copolymer, Acrylate/Aminoacrylate Copolymer, and mixtures thereof.

Non-limiting examples of suitable polyethylene glycol polymers include Ethylene/Acrylic Acid Copolymer, Ethylene/Acrylic Acid/VA Copolymer, Ethylene/Calcium Acrylate Copolymer, Ethylene/MA Copolymer, Ethylene/Magnesium Acrylate Copolymer, Ethylene/Methacrylate Copolymer, Ethylene/Propylene Copolymer, Ethylene/Sodium Acrylate Copolymer, Ethylene/VA Copolymer, Ethylene/Zinc Acrylate Copolymer, Ethyl Ester of PVM/MA Copolymer, Polyethylene, Polyethylene Terephthalate, and mixtures thereof.

Non-limiting examples of suitable polyvinyl alcohol polymers include Lauryl Acrylate/VA Copolymer, Polyvinyl Acetate, Polyvinyl Alcohol, Polyvinyl Butyral, Polyvinylcaprolactam, Polyvinyl Chloride, Polyvinyl Imidazolinium Acetate, Polyvinyl Laurate, Polyvinyl Methyl Ether, Polyvinyl Stearyl Ether, VA/Butyl Maleate/Isobornyl Acrylate Copolymer, VA/Crotonates Copolymer, VA/Crotonates/Methacryloxybenzophenone-1 Copolymer, VA/Crotonates/Vinyl Neodecanoate Copolymer, VA/Crotonates/Vinyl Propionate Copolymer, VA/Crotonic Acid/PEG-20M Copolymer, VA/DBM Copolymer, VA/Isobutyl Maleate/Vinyl Neodecanoate Copolymer, VA/Vinyl Butyl Benzoate/Crotonates Copolymer, Sodium MA/Vinyl Alcohol Copolymer, Styrene/VA Copolymer, and mixtures thereof.

Non-limiting examples of suitable polyvinylpyrrolidone polymers include Butylated PVP, PVP, PVP/Dimethiconylacrylate/Polycarbamyl/Polyglycol Ester, PVP/Dimethylaminoethylmethacrylate Copolymer, PVP/Dimethylaminoethylmethacrylate/Polycarbamyl Polyglycol Ester, PVP/Eicosene Copolymer, PVP/Hexadecene Copolymer, PVP Montmorillonite, PVP/Polycarbamyl Polyglycol Ester, PVP/VA Copolymer, PVP/VA/Itaconic Acid Copolymer, PVP/VA/Vinyl Propionate Copolymer, Styrene/PVP Copolymer, Poly(1-Vinylpyrrolidone-co-acrylic acid) Copolymer, and mixtures thereof.

Non-limiting examples of suitable starch and modified starch polymers include Corn Starch/Acrylamide/Sodium Acrylate Copolymer, Corn Starch Modified, Waxy Maize Starch, and mixtures thereof.

Non-limiting examples of other suitable particulate-controlling polymers include Butoxy Chitosan, Carboxybutyl Chitosan, Carboxymethyl Chitosan, Carboxymethyl Chitosan Succinamide, Chitosan, Chitosan Adipate, Chitosan Ascorbate, Chitosan Formate, Chitosan Glycolate, Chitosan Lactate, Chitosan PCA, Chitosan Salicylate, Chitosan Succinamide, Polyquaternium, Polysilicone, Polystyrene, Polyurethane, Isomalto-oligosaccaride, and mixtures thereof.

Other suitable particulate-controlling polymers are disclosed in U.S. Pat. Nos. 4,048,369 and 6,117,440; and in Robert L. Davidson (ed.), HANDBOOK OF WATER-SOLUBLE GUMS AND RESINS (McGraw-Hill 1980).

In preferred compositions, the particulate-controlling polymer is not a methacrylate polymer.

### Plasticizers

The compositions used in the present methods and articles can optionally further comprise one or more plasticizers. Plasticizers can be highly preferred ingredients because plasticizers allow for incorporation of a much wider range of particulate-controlling polymers in the compositions of the present methods and articles. Plasticizers tend to lower the overall glass transition temperature of the film resulting from evaporation of the composition from the treated surface, therefore enabling the use of polymers having higher glass transition temperatures than could otherwise be used.

Non-limiting examples of plasticizers include C₄-C₂₄ monohydric alcohols and polyhydric alcohols. Suitable C₄-C₂₄ monohydric alcohols include butanol, pentanol, dodecanol, hexadecanol, and mixtures thereof. Polyhydric alcohols useful as plasticizers in the present composition include glycols such as ethylene glycol, diethylene glycol, triethylene glycol, propylene glycol, dipropylene glycol, glycerine, mixtures thereof, and the like. Other suitable plasticizers include water-miscible ethers, water-miscible glycol ethers, and propylene glycol monomethyl ether acetate. Non-limiting examples of water-miscible ethers include diethylene glycol diethylether, diethyleneglycol dimethylether, propylene glycol dimethylether, and mixtures thereof. Non-limiting examples of water-miscible glycol ethers include propylene glycol monomethylether, propylene glycol monoethylether, propylene glycol monopropylether, propylene glycol monobutylether, ethylene glycol monobutylether, dipropylene glycol monomethylether, diethyleneglycol monobutylether, and mixtures thereof.

Non-limiting examples of other suitable plasticizers include Acetyl Tributyl Citrate, Acetyl Triethyl Citrate, Acetyl Triethylhexyl Citrate, Acetyl Trihexyl Citrate, Butyl Benzyl Phthalate, Butyloctyl Benzoate, Butyl Phthalyl Butyl Glycolate, Butyroyl Trihexyl Citrate, Camphor, Decyloxazolidinone, Dibutyl Adipate, Dibutyl Oxalate, Dibutyl Phthalate, Dibutyl Sebacate, Dicapryl Adipate, Diethylene Glycol Dibenzoate, Diethylene Glycol, Diethylhexanoate/Diisononanoate, Diethylene Glycol Diisononanoate, Diethylhexyl Adipate, Diethylhexyl Phthalate, Diethylhexyl Sebacate, Diethylhexyl Succinate, Diethyl Oxalate, Diethyl Phthalate, Diethyl Sebacate, Diethyl Succinate, Diisobutyl Adipate, Diisobutyl Oxalate, Diisocetyl Adipate, Diisodecyl Adipate, Diisononyl Adipate, Diisopropyl Adipate, Diisopropyl Oxalate, Diisopropyl Sebacate, Diisostearyl Adipate, Dimethicone Copolyol Polyacrylate, Dimethyl Adipate, Dimethyl Oxalate, Dimethyl Phthalate, Dioctyldodecyl Adipate, Dipropyl Oxalate, Epoxidized Soybean Oil, Ethyl Tosylamide, Hexyldecyl Benzoate, Isodecyl Citrate, Isopropyl Citrate, Neopentyl Glycol, PEG-800, PEG-8/SMDI Copolymer, PPG-26/HDI Copolymer, PPG-35/PPG-51 Glyceryl Ether/IPDI Crosspolymer, PPG-12/SMDI Copolymer, PPG-26/TDI Copolymer, Sucrose Acetate Isobutyrate, Sucrose Benzoate, Tosylamide/Epoxy Resin, Tosylamide/Formaldehyde Resin, Triacetin, and mixtures thereof.

Other suitable plasticizers are disclosed in Robert L. Davidson (ed.), HANDBOOK OF WATER-SOLUBLE GUMS AND RESINS (McGraw-Hill 1980).

When present, the level of plasticizer in the compositions of the present methods is generally from about 0.01% to about 20%, preferably from about 0.05% to about 10%, and more preferably from about 0.1% to about 5%, by weight of the composition. In preferred compositions, such as spray compositions, the level of plasticizer is preferably less than about 5%, more preferably less than about 4%, and more preferably less than about 3%, by weight of the composition.

Insect and/or Moth Repelling Agent

The composition of the present invention can optionally contain an effective amount of insect and/or moth repelling agents. Typical insect and moth repelling agents are pheromones, such as anti-aggregation pheromones, and other natural and/or synthetic ingredients. Preferred insect and moth repellent agents useful in the composition of the present invention are perfume ingredients, such as citronellol, citronelial, citral, linalool, cedar extract, geranium oil, sandalwood oil, 2-(diethylphenoxy)ethanol, I-dodecene, etc. Other examples of insect and/or moth repellents useful in the composition of the present invention are disclosed in U.S. Pat. Nos. 4,449,987, 4,693,890, 4,696,676, 4,933,371, 5,030,660, 5,196,200, and in “Semio Activity of Flavor and Fragrance Molecules on Various Insect Species”, B. D. Mookherjee et al., published in Bioactive Volatile Compounds from Plants, ASC Symposium Series 525, R. Teranishi, R. G. Buttery, and H. Sugisawa, 1993, pp. 35-48.

When an insect and/or moth repellent is used it is typically present at a level of from about 0.005% to about 3%, by weight of the usage composition.

### Colorant

Colorants and dyes, especially bluing agents, can be optionally added to the color restoration compositions for visual appeal and performance impression. One example would be improving the appearance of blue denim. Another example would be to restore the whiteness and/or brightness to dingy white fabrics. In this case, hueing dyes and brighteners can be used. Non-limiting examples of useful hueing dyes and brighteners can be found in US Patent Application No. 20060079438A1, incorporated herein by reference. When colorants are used, they are used at extremely low levels to avoid fabric staining. Preferred colorants for use in the present compositions are highly water-soluble dyes, e.g., Liquitint® dyes available from Milliken Chemical Co. Non-limiting examples of suitable dyes are, Liquitint® Blue HP, Liquitint® Blue 65 , Liquitint® Patent Blue , Liquitint® Royal Blue , Liquitint Experimental Yellow 8949-43 Liquitint Green HMC®, Liquitint Yellow II®, and mixtures thereof, preferably Liquitint® Blue HP®, Liquitint® Blue 65 , Liquitint Patent Blue®, Liquitint Royal Blue®, Liquitint Experimental Yellow 8949-43®, Liquitint® Blue DW, Liquitint® Blue EM, Liquitint® Violet CT, Liquitint® Violet LS and mixtures thereof. It should be understood, however, that the compositions described herein will provide a visible color restoration of colored, faded fabrics without the presence of any colorant or dye.

### Optional Anti-Clogging Agent

Optional anti-clogging agent which enhances the wetting and anti-clogging properties of the composition, especially when starch is present, is chosen from the group of polymeric glycols of alkanes and olefins having from 2 to about 6, preferably 2 carbon atoms. The anti-clogging agent inhibits the formation of “plugs” in the spray nozzle. An example of the preferred anti-clogging agent is polyethylene glycol having an average molecular weight of from about 800 to about 12,000, more preferably from about 1,400 to about 8,000. When used, the anti-clogging agent is present at a level of from about 0.01% to about 1%, preferably from about 0.05% to about 0.5%, more preferably, from about 0.1% to about 0.3% by weight of the usage composition.

### Structuring Agents

Compositions of the present invention may contain a structurant or structuring agent. Structurants may be useful to suspend perfume microcapsules for improved stability. Suitable levels of this component are in the range from about 0% to 20%, preferably from 0.001% to 10%, and even more preferably from 0.05% to 3% by weight of the composition. The structurant may also serve to stabilize the silicone polymer in the inventive compositions and to prevent it from coagulating and/or creaming.

Structurants suitable for use herein can be selected from thickening stabilizers. These include gums and other similar polysaccharides, for example gellan gum, carrageenan gum, xanthan gum, Diutan gum (ex. CP Kelco) and other known types of thickeners and rheological additives such as Rheovis CDP and Rheovis CDE (ex. Ciba Specialty Chemicals), Alcogum L-520 (ex. Alco Chemical), Methocels, Carbopols, and Sepigel 305 (ex. SEPPIC).

One preferred structurant is a crystalline, hydroxyl-containing stabilizing agent, more preferably still, a trihydroxystearin, hydrogenated oil or a derivative thereof.

Without intending to be limited by theory, the crystalline, hydroxyl-containing stabilizing agent is a nonlimiting example of a “thread-like structuring system.” “Thread-like Structuring System” as used herein means a system comprising one or more agents that are capable of providing a chemical network that reduces the tendency of materials with which they are combined to coalesce and/or phase split. Examples of the one or more agents include crystalline, hydroxyl-containing stabilizing agents and/or hydrogenated jojoba. Surfactants are not included within the definition of the thread-like structuring system. Without wishing to be bound by theory, it is believed that the thread-like structuring system forms a fibrous or entangled threadlike network in-situ on cooling of the matrix. The thread-like structuring system has an average aspect ratio of from 1.5:1, preferably from at least 10:1, to 200:1. A process for the preparation of a thread-like structuring system is disclosed in WO 02/18528.

Other preferred stabilizers are uncharged, neutral polysaccharides, gums, cellulosic polymers, and polymers like polyvinyl alcohol, polyacrylamides, polyacrylates and co-polymers, and-the like.

### Carrier

The preferred carrier of the present invention is water. The water which is used can be distilled, deionized, or tap water. Water is the main liquid carrier due to its low cost, availability, safety, and environmental compatibility. Aqueous solutions are also preferred when wrinkle control and odor control benefits are desired.

Water is very useful for fabric wrinkle removal or reduction. Not to be bound by theory, it is believed that water breaks many intrafiber and interfiber hydrogen bonds that keep the fabric in a wrinkle state. It also swells, lubricates and relaxes the fibers to help the wrinkle removal process.

Water also serves as the liquid carrier for the cyclodextrins, and facilitates the complexation reaction between the cyclodextrin molecules and any malodorous molecules that are on the fabric when it is treated. The dilute aqueous solution also provides the maximum separation of cyclodextrin molecules on the fabric and thereby maximizes the chance that an odor molecule will interact with a cyclodextrin molecule. It has recently also been discovered that water has an unexpected odor controlling effect of its own. It has been discovered that the intensity of the odor generated by some polar, low molecular weight organic amines, acids, and mercaptans is reduced when the odor-contaminated fabrics are treated with an aqueous solution. Not to be bound by theory, it is believed that water solubilizes and depresses the vapor pressure of these polar, low molecular weight organic molecules, thus reducing their odor intensity.

The level of liquid carrier in the compositions of the present invention is typically greater than about 80%, preferably greater than about 90%, more preferably greater than about 95%, by weight of the composition. When a concentrated composition is used, the level of liquid carrier is typically from about 50% to about 98%, by weight of the composition, preferably from about 60% to about 97%, more preferably from about 70% to about 95%, by weight of the composition.

Optionally, in addition to water, the carrier can contain a low molecular weight organic solvent that is highly soluble in water, e.g., ethanol, n-propanol, isopropanol, n-butanol, tert-butyl alcohol deodorized acetone, acetone, and the like, and mixtures thereof. Low molecular weight alcohols can help the treated fabric to dry faster. Other solvents can also be used such as ethers of ethylene glycol and propylene glycol (e.g., ethylene glycol monohexyl ether) and glycols such as glycerin, propylene glycol, dipropylene glycol, ethylene glycol, and the like. Other non-limiting examples include 1,3-propanediol, diethylene glycol, 1,2,3-propanetriol, propylene carbonate, phenylethyl alcohol, 2-methyl 1,3-propanediol, hexylene glycol, sorbitol, polyethylene glycols, 1,2-hexanediol, 1,2-pentanediol, 1,2-butanediol, 1,4 butanediol, 1,4-cyclohexanedimethanol, pinacol, 1,5-hexanediol, 1,6-hexanediol, 2,4-dimethyl-2,4-pentanediol, 2,2,4-trimethyl-1,3-pentanediol (and ethoxylates), 2-ethyl-1,3-hexanediol, phenoxyethanol (and ethoxylates), other glycol ethers such as butyl carbitol and dipropylene glycol n-butyl ether, ester solvents such as dimethyl esters of adipic, glutaric, and succinic acids, and mixtures thereof. The optional solvent is also useful in the solubilization of some shape retention polymers and some silicone polymers described hereinbefore. The optional water soluble low molecular weight solvent can be used at a level of up to about 75%, typically from about 0.1% to about 25%, preferably from about 2% to about 15%, more preferably from about 5% to about 10%, by weight of the total composition. Factors that need to be considered when a high level of solvent is used in the composition are cost, odor, flammability, and environmental impact. Flammable organic solvents are not preferred if the intended use of the composition is to dispense it (for example, spray) into an automated clothes dryer,

### Article of Manufacture

The composition of the present invention can also be used in an article of manufacture comprising said composition plus a spray dispenser. Preferably the articles of manufacture are in association with instructions for how to use the composition to treat faded colored fabrics, e.g., the manner and/or amount of composition to spray. If reduced wrinkle benefits are desired, then preferably the articles of manufacture are in association with instructions for how to use the composition to treat wrinkled fabrics correctly, including, e.g., the manner and/or amount of composition to spray, and the preferred ways of stretching and/or smoothing of the fabrics, as will be described with more detailed herein below. It is important that the instructions be as simple and clear as possible, so that using pictures and/or icons is desirable and preferred.

The article of manufacture can also comprise the composition of the present invention in a container in association with a set of instructions to use the composition in an amount effective to provide a solution to problems involving and/or provision of a benefit, in addition to color restoration of fabrics, related to those selected from the group consisting of: killing, or reducing the level of, microorganisms; reducing wrinkles; and/or reducing static in addition to the reduction in odors, providing fabric freshness, and providing fabric freshness that last over a long period of time, fabric softness, protection against abrasion, and anti-wear benefits. It is important that the consumer be aware of these additional benefits, since otherwise the consumer would not know that the composition would solve these problems and/or provide these benefits.

As used herein, the phrase “in association with” means the set of instructions are either directly printed on the container itself or presented in a separate manner including, but not limited to, a brochure, print advertisement, electronic advertisement, and/or verbal communication, so as to communicate the set of instructions to a consumer of the article of manufacture. The set of instructions preferably comprises the instruction to apply an effective amount of the composition, preferably by spraying, to provide the indicated benefit, e.g., wrinkle reduction, antimicrobial action, softness, freshness, odor control and/or reduction, and/or anti-static effect and, optionally the provision of the main effect of color restoration of fabrics.

The container for compositions of the instant invention is typically a plastic bottle (from polyethylene, polypropylene, PET, and mixtures) or a pressurizable aerosol can (from glass, plastic, tinplate, or aluminum). Compositions are preferably clear or translucent, and in many cases it is preferred to package the composition in a clear or translucent bottle (from plastic or glass). By being in a clear or translucent bottle, the consumer can see that the composition is clear or translucent and can thus be reassured that the composition is safe to spray on their fabrics (i.e., it will not leave a stain).

If the article is an aerosol, it is preferably packaged in aluminum or plastic “can”. These are more durable, are resistant to corrosion, and can be easily decorated with graphics, pictures, symbols, icons, and instructions for use.

### Spray Dispenser

The article of manufacture herein comprises a spray dispenser. The fabric color restoration composition is placed into a spray dispenser in order to be distributed onto the fabric. Said spray dispenser for producing a spray of liquid droplets can be any of the manually activated means as is known in the art, e.g. trigger-type, pump-type, non-aerosol self-pressurized, and aerosol-type spray means, for treating the color restoration composition to small fabric surface areas and/or a small number of garments, as well as non-manually operated, powered sprayers (such as battery operated and electrostatic sprayers) for conveniently treating the color restoration composition to large fabric surface areas and/or a large number of garments. The spray dispenser herein does not normally include those that will substantially foam the clear, aqueous color restoration composition. It is believed that the performance is increased by providing smaller particle droplets to give better distribution of the silicone polymer on the fabric. Desirably, the Sauter mean particle diameter is from about 10 μm to about 150 μm, more preferably, from about 20 μm to about 100 μm. Dewrinkling benefits can be improved by providing small particles (droplets), as discussed hereinbefore, especially when the surfactant is present.

Particle Size Method for Sprays

### Principle and Scope

This test procedure is used to determine the Sauter mean diameter particle size D[3,2] of an aerosol or non-aerosol spray.

| APPARATUS | SUGGESTED TYPE OR EQUIVALENT |
|---|---|
| Constant Temperature Water Bath | Capable of controlling the temperature to 21 ± 1° C. |
| Fume Hood | Capable of extracting VOC's and propellants |
| Particle size analyzer. | Malvern 2600 Particle Size Analyzer from Malvern |
| | Instruments Ltd. (Ingleside, IL) |
| Lab jack | Brookfield Engineering |
| Thermal sensitive paper | Hewlett Packard P/N 5080-8735, Z fold, 8.5 × 11 |
| | inches, Hewlett Packard Scanjet 4c |
| Personal Computer | Any manufacturer computer equipped with the |
| | software to run the Malvern 2600. |

### Procedure

### Preparation of Samples

Test samples (non-aerosol bottles or aerosol cans) should be coded appropriately
Test samples (non-aerosol bottles or aerosol cans) should be 20-24° C. If necessary condition bottles or cans in the water bath at 21±1° C. until they are at 21° C.

Preparation/Operation of Malvern 2600
1. Test is run at a room temperature of 20 to 24° C. and measured with a calibrated thermometer. Check temperature recorder before each test and do not run the test if the room temperature is outside the specified range.
2. The fume hood must be “on” to ensure adequate removal of VOC's and propellants.
3. For non-aerosols ensure the actuator supply air is “on”. Adjust the automatic actuator's pressure regulator until the calibrated gauge reads 80-85 psig.
4. For non-aerosols verify the air flow rate of the actuator is 14 liters/minute (±3 liters/minute) with a calibrated flow meter. This process is done by connecting the tubing and needle valve from the top of the automatic actuator to the back of the flow meter. Depress the button and adjust the air flow to the specified range with the needle valve.
5. Turn on the laser.
   a. Remove both lens caps.
   b. Turn the key on the left end of the laser to the ON position.
6. Turn the computer ON and load the test configuration.
   A. Turn the computer and the monitor
   B. Wait until the “#1 Programs” menu comes up.
      a. Type in “B”, enter password (APDO) then press enter.
      b. Enter F1 for 2600 BO when Malvern menu window appears. Malvern software will now load up.
      c. When “Easy Sizer Menu” appears type in “M” and press enter.
      d. The “Summary of equipment parameters” menu will appear check for the kill data.
      e. Before testing check chart below to make sure you are running the right kill low data for the product.

| Kill data low setting for Non- | Kill data low setting for |
|---|---|
| aerosol | Aerosol |
| 0 | 1 |

f. If you need to change the kill, type in “kil 0” for non-aerosol.
g. If you need to change the kill, type in “kil 1” for aerosol.
7. For non-aerosols prime the test pump and actuate a minimum of 5-10 additional times to ensure that all pump components are seated and functioning.
8. For non-aerosols position the bottle in the automatic actuator. Raise the bottle until the pump actuator fits snug against the air cylinder without depressing the button. Slide a rigid shim under the bottle to maintain the correct bottle height.
9. Position the test specimen so that laser beam intersects the centerline of the spray cloud and the spray cloud is perpendicular to the laser beam. Distance from laser beam to orifice for a non-aerosol is 6 inches and 8 inches for an aerosol. NOTE: To run in manual mode, see Manual Configuration.
10. Press F4 function key.
11. Wait while Measuring Background window appears.
12. Wait while Executing Measuring Background window appears.
13. When Measuring Sample Screen window appears start spraying the spray until the Executing Calculations Screen window comes up then stop spraying and wait while calculations are being calculated.
14. When Calculations Status window screen appears record the Sauter mean diameter-D[3,2] on the data sheet.
15. Remove test can or bottle.
16. Repeat step 7 through 15 for non-aerosol and step 9 through 15 for aerosol until all samples have been tested.
17. Upon completion of testing, of non-aerosols close the incoming air valve. Depress and release the timer switch until the gauge reads 0 psig. Depressing and releasing the switch will in turn reduce the system pressure to 0 psig.

### Manual Configuration:

1. Set equipment parameters by entering “dis par” and check for kill low data see chart below:

| Kill data low setting for Non-aerosol | Kill data low setting for Aerosol |
|---|---|
| 0 | 1 |

a. If you need to change the kill, type in “kil 0” for non-aerosol.
b. If you need to change the kill, type in “kil 1” for aerosol.
2. Type command “m b” and press enter. This measures background light scattering. Check that reading for Ring 0 is approximately 550 this shows good alignment. Check that readings for Rings 1 to 31 are 10 or below. This confirms that the lens are clean. If reading for Rings 1 to 31 are 20 and above, clean lens. Repeat check alignment and background measurement.
3. Position the test specimen so that laser beam intersects the centerline of the spray cloud and the spray cloud is perpendicular to the laser beam. Distance from laser beam to orifice for a non-aerosol is 6 inches and 8 inches for an aerosol.
4. Type the following string of commands(or press function key F2):
   m:cal:dis res:sam ed:dis dia
5. Then press the enter key.
6. Begin spraying the test specimen by depressing the palm button, and press enter key on the keyboard. The Malvern will begin measuring sample. Continue to spray for approximately 10 seconds until analysis is complete and the screen changes.
7. Press the “end button” on the keyboard. Record Sauter mean diameter D[3,2] on appropriate data sheet.
8. To measure next sample position sample and press F2. This recalls the last string of commands entered. Continue for all remaining samples.
9. Upon completion of testing, of non-aerosols close the incoming air valve. Depress and release the timer switch until the gauge reads 0 psig. Depressing and releasing the switch will in turn reduce the system pressure to 0 psig.

### Maintenance: Malvern 2600 Series Particle Size Analyzer

Clean lenses at least once per week

### Special Safety Precautions

Ensure that the fume hood is switched on during the test.
Ensure the proper personal protection equipment is worn.
Before testing ensure that you have received and read the COSHHIMSDS other assessment for the product formulation that you are testing.

### System Suitability/Quality Control Requirements: Malvern 2600 Series Particle Analyzer

Completed by Malvern yearly

### Reporting of Results

Record the Sauter mean diameter D[3,2]

The spray dispenser can be an aerosol dispenser. Said aerosol dispenser comprises a container which can be constructed of any of the conventional materials employed in fabricating aerosol containers. The dispenser must be capable of withstanding internal pressure in the range of from about 20 to about 180 p.s.i.g., more preferably from about 20 to about 160 p.s.i.g., and even more preferably from about 20 to about 130 p.s.i.g. The one important requirement concerning the dispenser is that it be provided with a valve member which will permit the preferably clear or translucent fabric color restoration composition contained in the dispenser to be dispensed in the form of a spray of very fine, or finely divided, particles or droplets. The aerosol dispenser utilizes a pressurized sealed container from which the fabric color restoration is dispensed through a special actuator/valve assembly under pressure. The aerosol dispenser is pressurized by incorporating therein a gaseous component generally known as a propellant. Common aerosol propellants, e.g., gaseous hydrocarbons such as isobutane, butane, and propane, mixed halogenated hydrocarbons, and Propellant 152a can be used. Halogenated hydrocarbon propellants such as chlorofluoro hydrocarbons have been alleged to contribute to environmental problems, and are not preferred. When cyclodextrin is present hydrocarbon propellants are not preferred, because they can form complexes with the cyclodextrin molecules thereby reducing the availability of uncomplexed cyclodextrin molecules for odor absorption. Preferred propellants are compressed air, nitrogen, inert gases, carbon dioxide, etc. A more complete description of commercially available aerosol-spray dispensers appears in U.S. Pat. Nos. 3,436,772, Stebbins, issued Apr. 8, 1969; and U.S. Pat. No. 3,600,325, Kaufman et al., issued Aug. 17, 1971.

Preferably the spray dispenser can be a self-pressurized non-aerosol container having a convoluted liner and an elastomeric sleeve. Said self-pressurized dispenser comprises a liner/sleeve assembly containing, a thin, flexible radially expandable convoluted plastic liner of from about 0.010 to about 0.020 inch thick, inside an essentially cylindrical elastomeric sleeve. The liner/sleeve is capable of holding a substantial quantity of color restoration composition product and of causing said product to be dispensed. A more complete description of self-pressurized spray dispensers can be found in U.S. Pat. Nos. 5,111,971, Winer, issued May 12, 1992, and U.S. Pat. No. 5,232,126, Winer, issued Aug. 3, 1993. Another type of aerosol spray dispenser is one wherein a barrier separates the color restoration composition from the propellant (preferably compressed air or nitrogen), as disclosed in U.S. Pat. No. 4,260,110, issued Apr. 7, 1981. Such a dispenser is available from EP Spray Systems, East Hanover, N.J.

### Coefficient of Friction (COF) Test

In accordance with a preferred embodiment of the compositions and methods described herein, the color restoration composition includes a static friction-increasing agent (anti-slip agent) that increase the static coefficient of friction of the dried composition to a value of at least 0.4, preferably at least 0.5, using the COF Test method.

Apparatus. The user is responsible for assuring that the BOT-3000 unit (available from Nu-Safe Floor Solutions, Inc., Walton, Ky.) is fully charged before using. The instructions for charging the unit are in section 2 of the user manual. The user is responsible for the validation of the BOT-3000 system (both the unit and sensor) prior to use. The instructions for validation of the unit and the sensor can be found in section 3 of the User Manual.

Reagents & Solutions. The user must provide DI water for the cleaning of the sensor validation panel included with the BOT-3000 unit. The user must provide Mr. Clean® Antibacterial Multi-Surface Spray and isopropyl alcohol for cleaning the flooring surface prior to testing. The user must provide any solutions to be applied to the flooring for COF (static coefficient of friction) testing. Sandpaper (100 grit-red) is required to resurface the sensor between treatments.

Facilities. The test must be performed on a stable, solid level surface, such as a counter-top or the floor. Vibration can result in variable test results.

Procedures. Cleaning flooring sample to be used for testing using Mr. Clean® Antibacterial Multi-Surface cleaning spray and Bounty® paper towel. When the flooring sample is dry, wipe the isopropyl alcohol wipe to ensure the removal of any residue remaining on the flooring. Apply the liquid product being tested to the clean, dry flooring sample (about 2 g are dispensed from the aerosol can). Using a Bounty® paper towel, lightly spread the liquid product over the entire test area. A test area 3 inches wide and 24 inches long is typically sufficient. Allow the product to completely dry on the flooring.

Once the BOT-3000 system has been verified and validated, place the unit onto the flooring sample so that the sensor is traveling over the treated area. Be certain that the unit is straight on the flooring so that the sensor will remain in contact with the treated area and that the unit will remain on the flooring sample, without rolling off the side. Keep the wheels of the unit out of the treated area in order to prevent contamination or invalid readings due to wheel slipping.

When using the Neolite sensor (gold colored housing), press the button marked “RUN WET (NFSI)”. The panel will display “Enter Facility#”. The user may either enter a facility code or press the “VERIFY/SETUP” button. When the test is completed, the unit will stop on the flooring sample and a printout may be obtained at this time. Press the “PRINT WITH GRAPH” button for a full report or the “PRINT TEXT ONLY” button for a summary report. Repeat in the opposite direction across the flooring. For example, if the first time, the BOT-3000 moved across the flooring from right to left, it must now go from left to right. NOTE: A printout must be obtained after each test; results cannot be recalled beyond the last test performed. After the test is completed in both directions, remove the Neolite sensor and resurface_(sandpaper) it as described in the user manual, section 2.

System Suitability. Each time the unit will be used, it must be verified. Each sensor must be inspected for wear and verified prior to use.

The fabric appearance test, used to determine color restoration results on non-white, faded fabrics is as follows:

### Fabric Appearance Test

Apparatus. ColorQuest Spectrophotometer LAV unit
Set UV filter to “OUT”, port size to 2 inches, illuminate is D65, scale is CIELAB and “observer” to 10*. Note: the L value from the CIE L*a*b* (CIELAB) color scale is used in the examples.
Kenmore 80 Series washing machines.
Standard US dryers (Kenmore or Maytag).

Reagents & Solutions. AATCC 1993 without brighteners (Standard Reference Detergent WOB) powder

Procedure. Assemble ballast load for each spray treatment to be tested. Each ballast load should be approximately 7.5 lbs and consist of 75% cotton/25% polyester by weight. The garments included are listed below:
3-Black chino twill swatches, 12″×12″ with edges surged and ID tags attached (from EMC)
3-Black gap socks with ID tags attached (from EMC, Empirical Manufacturing Company, Inc., 7616 Reinhold Dr., Cincinnati, Ohio 45237-3208).
3-Blue Outer Banks polo shirts, size men's medium, 100% cotton, interlock knit fabric (from General Advertising Products, Inc., 12150 Northwest Blvd., PO Box 46880, Cincinnati, OH 45246-0880.
3-Black Outer Banks polo shirts, size men's medium, 100% cotton, interlock knit fabric (from General Advertising Products, Inc.)
About 8-CW25 pluses (from EMC)—as cotton filler for ballast.
About 15-PW19 pluses (from EMC)—as polyester filler for ballast.

Label each garment using a relevant code, indicating the product type to be used, replicate number and garment type. Be sure to use a waterproof marker. Weigh the entire load to assure the total weight is between 7.25 and 7.75 lbs (add or remove pluses as needed).

Weigh out AATCC detergent at 66 grams (±0.25 grams) for each wash. The wash cycle will be repeated 10 times, so 10 doses will be needed for each fabric spray treatment grouping.

Set all washers to 90° F. wash using mixed water sources at 8 gpg hardness. Set each washer cycle to fill to 17 gallons (medium load). Set each washer to agitate/wash for 12 minutes on the “Ultra Clean” cycle. When about 2 inches of water are in the washer, add the AATCC and allow it to dissolve. When the washer is about half filled, add the ballast load to be washed. Check the load during the rinse cycle (water is 60° F.) to observe the amount of “suds” caused by detergent carryover. If there is a large amount (for example, the top of the water is covered by the “suds”), add a second rinse to the wash cycle.

To dry the clothes, keep each ballast load together (do not mix them) and use a standard US dryer (Kenmore or Maytag) on high heat for approximately 50 minutes until dry.

At the end of the 10 cycles, separate the pluses from the remainder of the load. Take the L* value reading for the polo shirts using the ColorQuest Spectrophotometer. Three readings will be taken from each side of the shirt, for a total of 6 per shirt. These values are averaged for each shirt.

Weigh each fully dried garment and record the weight. For each garment, calculate 8% of the total weight and this number will be the target amount of spray to be applied to the fabric. Hang each fabric garment on the rack set on the balance and set the balance to zero. Apply the spray product as close to the desired amount as possible and record the actual amount on the fabric. Allow all the garments to dry completely. Repeat the ColorQuest Spectrophotometer evaluation.

To evaluate the affect of the spray on the fabric appearance, compare the L* values after the 10 wash cycles with those after spraying and calculate the percent change of delta L* value as follows:

$$\frac{( L value after spraying ) - ( L value after 10 cycles ) \times 100}{( L value after 10 cycles )}$$

### EXAMPLES (PERCENTAGES ARE IN WEIGHT PERCENT)

| | Ingredient | | | |
|---|---|---|---|---|
| | A | B | C | D |
| | (%) | (%) | (%) | (%) |
| DC Q2-5247^{a} | — | 1.5 | 3.00 | 5.00 |
| Silwet L-7600^{b} | — | — | — | 1.00 |
| Ethanol | — | 3.00 | 9.90 | 9.90 |
| Hydroxypropyl Beta | — | 0.75 | 1.50 | 1.50 |
| Cyclodextrin (40%)^{c} | | | | |
| Luviflex Soft (30%)^{d} | — | 1.33 | 2.67 | 2.67 |
| Sodium Hydroxide (20%)^{e} | | 0.18 (as | 0.35 (as | 0.35 (as |
| | | needed) | needed) | needed) |
| Perfume | — | 0.045 | 0.20 | 0.20 |
| Proxel GXL (19.3%)^{f} | — | 0.08 | — | — |
| Acticide B 20 (20%)^{g} | — | — | 0.05 | 0.05 |
| DI Water | 100 | 93.12 | 82.33 | 79.33 |
| Total | 100 | 100 | 100 | 100 |

^{a}Silicone graft type polyether from Dow Corning (dimethyl, methylhydroxypropyl, ethoxylated propoxylated siloxane, primarily CAS# 68937-55-3) comprised of siloxane, EO, and PO.
^{b}Silicone polymer surfactant from GE (CAS# 68938-54-5) derived from polydimethyl siloxane to which ethylene oxide has been attached with a viscosity of about 4000 and methyl end capped.
^{c}Supplied as an aqueous solution (Cavitron 82057) from Cargill Incorporated.
^{d}A Copolymer of ethyl acrylate and methacrylic acid (CAS# 25212-88-8) supplied by BASF Corporation.
^{e}Sodium hydroxide solution usage adjusted to achieve a final composition pH range of about 6 to about 7.
^{f}A preservative of 1,2-benzisothiazolin-3-one (CAS#2634-33-5) supplied by THOR GmbH.
^{g}A preservative of 1,2-benzisothiazolin-3-one (CAS#2634-33-5) in water and dipropylene glycol supplied by Arch Chemicals.

### Fabric Appearance Test (as Percent Change in Delta L Value)

Fabric

| | A | B | C | D |
|---|---|---|---|---|
| | (%) | (%) | (%) | (%) |
| Blue Polo Shirt^{h} | −1.6 | −0.9 | −3.5 | −5.3 |
| Black Polo Shirt^{h} | −1.7 | −1.1 | −2.1 | −5.5 |

^{h}From OuterBanks, 100% cotton, interlock knit.

Average Static Coefficient of Friction (COF) Test Using the Walkway Universal tester (BOT-3000) with Neolite Sensor

| | C | D |
|---|---|---|
| Vinyl Plankⁱ | 0.52 | 0.47 |
| Hardwood Floor^{j} | 0.98 | 0.74 |

ⁱFlooring is Luxury Vinyl Plank Timber Series made by Novalis Home Fashions, 4 inches by 36 inches from Lowes.
^{j}Flooring is oak hardwood with a polyurethane finish (Minwax Fast-Drying Polyurethane Clear Semi-Gloss).

### Average Particle Size as D[3,2]

| | |
|---|---|
| Example C | 50 microns |
| Example D | 46 microns |

Examples C and D were made by the following procedure:
1. Add DI water to container.
2. Add Acticide B 20.
3. Add Luviflex Soft.
4. Add Hydroxypropyl Beta Cyclodextrin.
5. Add DC Q2-5247.
6. Add Silwet L-7600 (if present).
7. Add Ethanol.
8. Add Perfume.
9. Mix for about 5 minutes until all components appear blended.
10. Measure pH.
11. Add 20% NaOH slowly, while mixing, until a pH of 6.5 (±0.5) is reached.
12. Continue to mix for approximately 30 minutes.
13. Dispense 280 grams (±2 grams) into an empty aerosol can (DOT 2Q aluminum can).
14. Place valve into the filled can and crimp.
15. Gas the crimped can to 125 psig with nitrogen (about 2 grams).
16. Apply actuator to the can.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

As used herein, “essentially free of” is defined as containing only trace amounts. In one embodiment, this amount is less than about 1 %, alternatively less than about 0.5 %, alternatively less than about 0.1 %, alternatively less than about 0.01 %.

As used herein, “and/or” is defined as any combination of one or more elements of the specified set. For example, A and/or B is to be interpreted as either A, B, or A and B.

Except as otherwise noted, the articles “a,” “an,” and “the” mean “one or more.”

1. A method of restoring color in a colored and faded fabric, the method comprising spraying said fabric with a composition comprising a silicone polymer active and water, organic solvent, or mixtures thereof, wherein the sprayed composition provides an improvement in appearance benefit measured by the Fabric Appearance Test method of a percent change of delta L value of at least −2;
wherein the silicone polymer is a dimethyl, methylhydroxypropyl, ethoxylated propoxylated siloxane.

2. The method of claim 1, wherein the silicone polymer active is present in said composition in an amount of about 1.75 wt % to about 10 wt %, based on the total weight of the composition.

3. The method of claim 2 wherein the silicone polymer active is present in said composition in an amount of about 3 wt % to about 7 wt %, based on the total weight of the composition.

4. The method of claim 2 wherein the composition further comprises a perfume microcapsule.

5. The method of claim 4 1, wherein the composition further comprise a copolymer of ethyl acrylate and methacrylic acid.

6. The method of claim 1 wherein the solvent is selected from the group consisting of ethanol, n-propanol, isopropanol, butanol, tert-butyl alcohol, acetone, and mixtures thereof.

7. The method of claim 5, wherein the composition further comprises from a silicone polymer surfactant derived from polydimethyl siloxane to which ethylene oxide is attached and methyl end capped.

8. The method of claim 1 wherein the composition further comprises an anti-slip agent or mixture of anti-slip agents in an amount sufficient to provide the sprayed composition, when dried, with a static coefficient of friction of at least about 0.4 using the COF test method.

9. The method of claim 8 wherein the anti-slip agents are selected from the group consisting of polysaccharides, polymers, natural gums, surfactants, silicas, clays, and mixtures thereof.

10. The method of claim 9 wherein the anti-slip agents are starch or starch derivatives, sugar or sugar derivatives, cyclodextrins, polyacrylates, and mixtures thereof.

11. The method of claim 1 wherein the median particle size of the spray is from about 30 microns to about 100 microns.

12. The method of claim 11 wherein the spraying mechanism is a trigger sprayer.

13. The method of claim 11 wherein the composition is delivered to the fabric as an aerosol spray.

14. The method of claim 13 wherein the container includes nitrogen or carbon dioxide or mixtures as the spray propellant.

15. The method of claim 11 wherein the composition is delivered at a spray rate of about 0.1 grams per second to about 2 grams per second.

16. The method of claim 15 wherein the spray rate is about 0.5 grams per second to about 1.5 grams per second.

17. The method of claim 1 wherein the article is sprayed to deliver about 2 grams of the composition per square foot of fabric and produces a drying time for the fabric from about 5 minutes to about 15 minutes.

18. The method of claim 1, wherein the amount of composition sprayed onto the fabric is from about 1 gram to about 4 grams of the composition per square foot of fabric.

19-20. (canceled)
